(19) United States
(12) Patent Application Publication
(10) Pub. No.: US 2025/0297073 A1
(43) Pub. Date: Sep. 25, 2025

(54) BENZOXAZINE-BASED RESIN COMPOSITION, PREPREG, AND METHOD FOR PRODUCING RESIN COMPOSITION

(71) Applicant: KANEKA CORPORATION, Osaka (JP)

(72) Inventors: Hideki Yamamoto, Osaka (JP); Mari Yoshitake, Osaka (JP)

(73) Assignee: KANEKA CORPORATION, Osaka (JP)

(21) Appl. No.: 19/086,496

(22) Filed: Mar. 21, 2025

(30) Foreign Application Priority Data
Mar. 22, 2024 (JP) 2024-046891

(51) Int. Cl. C08J 5/24; C08G 12/08; C08J 3/24; C08J 11/28

(52) U.S. Cl. CPC C08J 5/243; C08G 12/08; C08J 3/247; C08J 11/28; C08J 2361/30

(57) ABSTRACT

Provided is an advantageous production method for a curable resin composition. A resin composition in accordance with the present disclosure is a resin composition that contains a compound (A) having a benzoxazine ring and an aldehyde group and an aromatic amine compound (B), wherein the resin composition contains the aldehyde group in an amount of not less than 50 mol %, and the resin composition contains a solvent in an amount of not less than 0% by weight and not more than 68% by weight, where 100 mol % represents a total amount of the aldehyde group and an imino group in the resin composition.

This Nonprovisional application claims priority under 35 U.S.C. § 119 on Patent Application No. 2024-046891 filed in Japan on Mar. 22, 2024, the entire contents of which are hereby incorporated by reference.

### TECHNICAL FIELD

The present invention relates to a resin composition that contains a compound having a benzoxazine ring, a method for p producing the resin composition, a prepreg that is obtained by use of the resin composition, and a fiber composite material that is a cured product of the prepreg.

### BACKGROUND ART

It is known that a benzoxazine compound cures in a case where a benzoxazine ring undergoes ring opening polymerization and/or a reaction with another compound by heat or the like. For example, Patent Literature 1 discloses a curable resin composition containing a benzoxazine compound. Patent Literature 1 also discloses a film, a prepreg, and the like each of which is obtained by use of the curable resin composition. Moreover, Patent Literature 2 discloses an imino group-containing benzoxazine resin that is capable of being decomposed after the imino group-containing benzoxazine resin has been cured. For example, by decomposition of a cured product (reinforcement fiber composite material) containing reinforcement fibers, recovery of a decomposition product and the reinforcement fibers becomes possible. There is a possibility of being able to reuse the recovered decomposition product as a resin raw material.

### CITATION LIST

### Patent Literatures

### Patent Literature 1

Japanese Patent Application Publication Tokukai No. 2014-148562

### Patent Literature 2

International Publication No. WO 2023/204169

### SUMMARY OF INVENTION

### Technical Problem

However, the conventional techniques as described above have room for improvement from the viewpoint of making a production process for a benzoxazine-based resin composition or a prepreg containing the benzoxazine-based resin composition more advantageous (simpler). Further, the conventional techniques also have room for improvement from the viewpoint of achieving a high solid content concentration of a solution which is used for producing the benzoxazine-based resin composition or the prepreg. An object of an aspect of the present invention is to realize a more advantageous (simpler) production process for a benzoxazine-based resin composition or a prepreg containing the benzoxazine-based resin composition. Further, an object of an aspect of the present invention is to realize a high solid content concentration of a solution which is used for producing the benzoxazine-based resin composition or the prepreg.

Therefore, the inventors of the present invention have conducted a study of further improvement of the production process in Patent Literature 2, and, as a result of diligent studies, have succeeded in designing a more advantageous production process.

### Solution to Problem

In order to solve the above problems, a method for producing a prepreg in accordance with an aspect of the present invention is a production method including the step of mixing, with reinforcement fibers, a resin composition containing a compound (A) having a benzoxazine ring and an aldehyde group and an aromatic amine compound (B), wherein the resin composition contains the aldehyde group in an amount of not less than 50 mol %, where 100 mol % represents a total amount of the aldehyde group and an imino group in the resin composition.

Further, in order to solve the above problems, a resin composition in accordance with an aspect of the present invention is a resin composition that contains a compound (A) having a benzoxazine ring and an aldehyde group and an aromatic amine compound (B), wherein the resin composition contains the aldehyde group in an amount of not less than 50 mol %, where 100 mol % represents a total amount of the aldehyde group and an imino group in the resin composition, and
the resin composition contains a solvent in an amount of not less than 0% by weight and not more than 68% by weight.

### Advantageous Effects of Invention

According to an aspect of the present invention, it is possible to provide a more advantageous (simpler) production process for a benzoxazine-based resin composition or a prepreg containing the benzoxazine-based resin composition. Further, it is also possible to achieve a high solid content concentration of a solution which is used for producing the benzoxazine-based resin composition or the prepreg. In a case where the solution has a high solid content concentration, for example, it becomes easier to evaporate a solvent in a prepreg.

### BRIEF DESCRIPTION OF DRAWINGS

FIG. 1 is a GPC chart (mobile phase: DMF) of imino group-containing benzoxazine compounds in Production Examples 1 to 3.

FIG. 2 is an IR chart of imino group-containing benzoxazine compounds in Production Examples 1 and 3 to 5 and Example 2.

FIG. 3 is a graph showing results of melt viscosity measurement of the imino group-containing benzoxazine compound in Production Example 3.

FIG. 4 is a GPC chart (mobile phase: chloroform) of imino group-containing benzoxazine compounds in Production Examples 1, 3, and 5.

FIG. 5 is a GPC chart (mobile phase: lithium chloride-containing DMF) of an imino group-containing benzoxazine compound in Production Example 6.

FIG. 6 is a graph showing DMA curves of cured molded products in Examples 2 and 7.

FIG. 7 is a graph showing results of melt viscosity measurement of the imino group-containing benzoxazine compound (dried solid) in Production Example 6.

FIG. 8 is a graph showing DMA curves of cured molded products in Comparative Examples 1 to 3.

FIGS. 9A-9D show results of an amine decomposability evaluation test (decomposability evaluation 1) in each of Examples and Comparative Examples.

FIGS. 10A-10B show results of a hydrolyzability evaluation test (decomposability evaluation 2) in each of Examples and Comparative Examples.

FIG. 11 is a view illustrating a method for preparing a carbon fiber reinforced plastic (CFRP).

FIG. 12 is a view showing the state of decomposition of CFRP in Example 13 (decomposability evaluation 1) and the states of r-CF and a decomposition resin solution which were separated from CFRP in Example 14.

FIG. 13 is a view showing the state of decomposition of CFRP in Example 15 (degradability evaluation 2).

### DESCRIPTION OF EMBODIMENTS

The following description will discuss examples of embodiments of the present invention in details. The present invention is, however, not limited to such examples. Any numerical range expressed as “A to B” herein means “not less than A and not more than B” unless otherwise specified in the present specification.

An aldehyde group in the present specification is a —CH(═O) group, and an imino group in the present specification is a —CH═N— group which is formed by a dehydration condensation reaction between an aldehyde group and an amino group. Further, a resin composition in the present specification may be a resin composition in a solid state or may be a resin composition in a solution state in which the resin composition is dissolved in a solvent.

### [1. Overview of the Present Invention]

The conventional method for producing a prepreg includes the following steps (1) to (5):

(1) A benzoxazine resin having an aldehyde group at a terminal thereof and an amine compound are reacted in a solution to prepare a polymer of an imino group-containing benzoxazine resin.

(2) The polymer obtained in the step (1) is isolated from the solution.

(3) The polymer isolated in the step (2) is dissolved in a solvent again.

(4) Reinforcement fibers are impregnated with a solution obtained in the step (3).

(5) After the impregnation, the solution is dried to obtain a prepreg.

However, in many cases, the degree of solubility of the polymer prepared in the step (1) with respect to the solvent cannot be said to be adequately high. Thus, the concentration of the polymer isolated in the step (2) becomes low in the solution used in the production of the prepreg, and there arises a necessity to remove a large amount of solvent in the drying step of obtaining the prepreg by use of the reinforcement fibers which have been impregnated with the polymer solution. In addition, many of solvents that can be used in the step (2) have a relatively high boiling point. For these reasons, there were many cases in which the drying in the step (3) requires a long period of time.

Therefore, the conventional method for producing a prepreg has room for improvement from the following viewpoints:
To make a production process for a benzoxazine-based resin composition or a prepreg containing the benzoxazine-based resin composition more advantageous (simpler).
To achieve a high solid content concentration of a solution which is used for producing the benzoxazine-based resin composition or the prepreg. That is, to reduce the amount of the solvent used.

In contrast, a method for producing a prepreg in accordance with an embodiment of the present invention does not require the step of dissolving the imino group-containing benzoxazine resin again, after the imino group-containing benzoxazine resin has been prepared and isolated. Thus, the production process is more advantageous (simpler) when compared to the conventional method for producing a prepreg. In addition, the method for producing a prepreg in accordance with an embodiment of the present invention uses a resin composition containing a compound (monomer) having a benzoxazine ring and an aldehyde group and an aromatic amine compound. The monomer has a high degree of solubility in a solvent, and a small amount of solvent is thus required. That is, the solution which is used for producing a benzoxazine-based resin composition or a prepreg has a high solid content concentration.

### [2. Resin Composition]

A resin composition in accordance with an embodiment of the present invention contains a compound (A) having a benzoxazine ring and an aldehyde group and an aromatic amine compound (B). The resin composition may be a resin composition in a solution state in which the resin composition is dissolved in a solvent or may be a resin composition in a solid state.

### (Compound (A) Having Benzoxazine Ring and Aldehyde Group)

The number of aldehyde groups in the compound (A) having a benzoxazine ring and an aldehyde group in accordance with an embodiment of the present invention is not limited in particular, but may be usually two to five, preferably two to three, and more preferably two.

The compound (A) having a benzoxazine ring and an aldehyde group may be a compound represented by the following general formula (I):

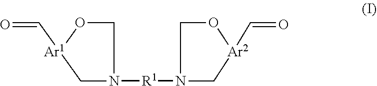

[In general formula (I), Ar¹ and Ar² each represent a trivalent aromatic group derived from a phenol compound. In the present specification, an aromatic group is intended to mean an organic group having at least one aromatic ring. Ar¹ and Ar² may be identical to or different from each other. R¹ represents a divalent aromatic group. The divalent aromatic group may be a divalent aromatic group derived from general formula (IIa) below or a divalent aromatic group represented by any of general formulas (III) to (V) below. In addition, Ar¹, Ar², and R¹ each do not have a C═N group.]

The compound (A) having a benzoxazine ring and an aldehyde group in accordance with an embodiment of the present invention can be produced by, for example, reacting a phenol compound, an aromatic diamine compound (Q), and an aldehyde compound.

The phenol compound is preferably a phenol compound having an aldehyde group. Examples of the phenol compound having an aldehyde group include 4-hydroxybenzaldehyde, 2-hydroxybenzaldehyde, and vanillin. In particular, from the viewpoint of ease of synthesis of the compound (A), the phenol compound is preferably 4-hydroxybenzaldehyde and/or vanillin, and more preferably 4-hydroxybenzaldehyde.

The aromatic diamine compound (Q) may be an aromatic diamine compound represented by general formula (IIa) below or an aromatic diamine compound containing a divalent aromatic group represented by any of general formulas (III) to (V) below, or may be another aromatic diamine compound. Examples of the another aromatic diamine compound include 1,4-bis(4-aminophenoxy)benzene, 2,2-bis[4-(4-aminophenoxy)phenyl]hexafluoropropane, and 2,2′-dimethylbiphenyl-4,4′-diamine.

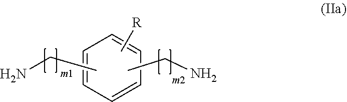

[In general formula (IIa), bonds to an aromatic ring which bonds form the main chain, except a bond between R and the aromatic ring, are in meta- or para-position. The R is a substituent on the aromatic ring and represents an aliphatic group having 1 to 10 carbon atoms. The number of Rs is zero or is one or more. In a case where the number of Rs is two or more, Rs may be identical to or different from each other. m1 and m2 each represent 0 or 1.]

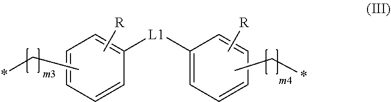

[In general formula (III), asterisks each represent a bonding site. Bonds to each of two aromatic rings which bonds form the main chain, except bonds between Rs and the two aromatic rings, are in meta- or para-position. L1 represents one or more of a single bond, an isopropylidene group, a sulfonyl group, a carbonyl group, and a 9,9-fluorenyl group. The Rs are substituents on the two aromatic rings and each represent an aliphatic group having 1 to 10 carbon atoms. The number of Rs on each of the two aromatic rings is zero or is one or more. In a case where the number of Rs is two or more, the Rs may be identical to or different from each other. m3 and m4 each represent 0 or 1.]

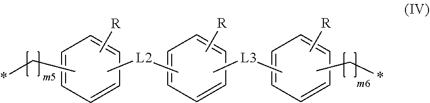

[In general formula (IV), asterisks each represent a bonding site. Bonds to each of three aromatic rings which bonds form the main chain, except bonds between Rs and the three aromatic rings, are in meta- or para-position. L2 and L3 each represent an oxy group. The Rs are substituents on the three aromatic rings and each represent an aliphatic group having 1 to 10 carbon atoms. The number of Rs on each of the three aromatic rings is zero or is one or more. In a case where the number of Rs is two or more, Rs may be identical to or different from each other. m5 and m6 each represent 0 or 1.]

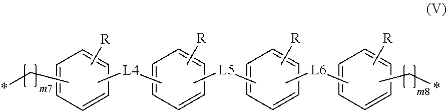

[In general formula (V), asterisks each represent a bonding site. Bonds to each of four aromatic rings which bonds form the main chain, except bonds between Rs and the four aromatic rings, are in meta- or para-position. L4 and L6 each represent an oxy group. L5 represents one or more of a single bond, an isopropylidene group, a sulfonyl group, a carbonyl group, and a 9,9-fluorenyl group. The Rs are substituents on the four aromatic rings and each represent an aliphatic group having 1 to 10 carbon atoms. In each of the aromatic rings, the number of Rs is zero or is one or more. In a case where the number of Rs is two or more, Rs may be identical to or different from each other. m7 and m8 each represent 0 or 1.]

In other words, the aromatic diamine compound (Q) is represented by any of general formulas (IIa) to (Va) below. In general formulas (IIa) to (Va), definitions of L1 to L6, R, and m1 to m8 are the same as those in general formulas (IIa) and (III) to (V).

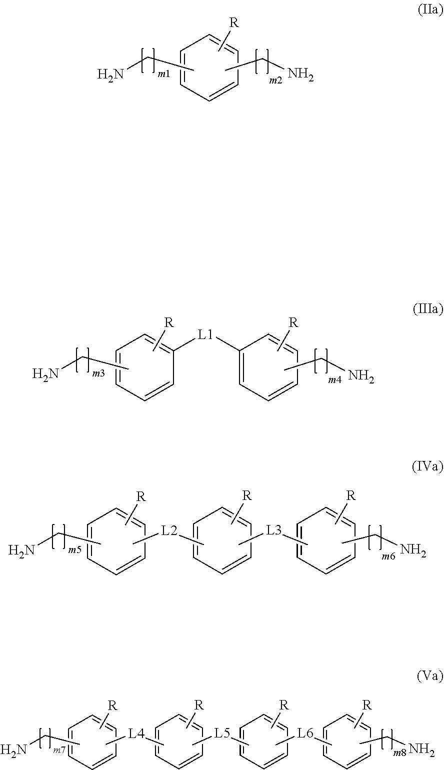

From the viewpoint of availability and ease of synthesis of the compound (A), the aromatic diamine compound (Q) is preferably at least one selected from the group consisting of 1,4-diaminobenzene, 1,3-diaminobenzene, 2,4-diaminotoluene, 2,6-diaminotoluene, 3-(aminomethyl)benzylamine, 4-(aminomethyl)benzylamine, 3,3′-sulfonyldianiline, 4,4′-sulfonyldianiline, 3,3′-diaminobenzophenone, 4,4′-diaminodiphenylmethane, 4,4′-diaminobenzophenone, 4,4′-diaminodiphenylether, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy) biphenyl, 4,4′-bis(4-aminophenoxy) biphenyl, and 9,9-bis(4-aminophenyl) fluorene. 3-(aminomethyl)benzylamine is also referred to as m-xylene-α,α′-diamine.

The aldehyde compound is not limited in particular, but is preferably formaldehyde. The formaldehyde can be paraformaldehyde, which is a polymer, formalin, which is in the form of an aqueous solution, or the like.

The molar ratio between the phenol compound and the aromatic diamine compound (Q) in the production of the compound (A) is preferably approximately 2:1, but may be 2.5/1 to 1.95/1. The molar ratio between the phenol compound and the aldehyde compound is preferably 1/1 to 1/20, and more preferably 1/2 to 1/6. In a case where the molar ratio between the phenol compound and the aldehyde compound falls within the above range, it is possible to suitably produce the benzoxazine ring.

During the production of the compound (A) having a benzoxazine ring and an aldehyde group in accordance with an embodiment of the present invention, a solvent can be used. Examples of the solvent include: halogen-based solvents such as chloroform; non-halogen-based aromatic hydrocarbon solvents such as toluene and xylene; ether-based solvents such as tetrahydrofuran (THF); cyclic diether-based solvents such as 1,4-dioxane and 1,3-dioxolane; high polarity and high boiling point solvents such as N,N-dimethylformamide, N,N-dimethylacetamide, N-methyl-2-pyrrolidone, N,N-diethylacetamide, N-methylcaprolactam, γ-butyrolactone, and dimethyl sulfoxide; and mixed solvents of non-halogen-based hydrocarbon solvents and aliphatic alcohol-based solvents. Examples of the aliphatic alcohol-based solvents include methanol, ethanol, propanol, and butanol (including structural isomers). From the viewpoint of suppression of a side reaction, it is preferable to use a non-halogen-based aromatic hydrocarbon solvent.

### (Aromatic Amine Compound (B))

The number of amino groups in the aromatic amine compound (B) in accordance with an embodiment of the present invention is not limited in particular, but may be usually two to five, preferably two to three, and more preferably two. In a case where the aromatic amine compound (B) in accordance with an embodiment of the present invention is an aromatic diamine compound, the aromatic diamine compound may be identical to or different from the aromatic diamine compound (Q). The aromatic diamine compound (B) may be an aromatic diamine compound represented by general formula (IIa) described above or an aromatic diamine compound containing a divalent aromatic group represented by any of general formulas (III) to (V) described above, or may be another aromatic diamine compound. Examples of the another aromatic diamine compound include 1,4-bis(4-aminophenoxy)benzene, 2,2-bis[4-(4-aminophenoxy)phenyl]propane, 2,2-bis[4-(4-aminophenoxy)phenyl]hexafluoropropane, and 2,2′-dimethylbiphenyl-4,4′-diamine.

The aromatic amine compound (B) may be at least one compound selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminodiphenylmethane, 4,4′-diaminodiphenylether, 4,4′-diaminobenzophenone, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy) biphenyl, 4,4′-bis(4-aminophenoxy) biphenyl, and 9,9-bis(4-aminophenyl) fluorene.

### [3. Method for Producing Resin Composition]

A resin composition in accordance with an embodiment of the present invention is produced by mixing a compound (A) having a benzoxazine ring and an aldehyde group and an aromatic amine compound (B). The compound (A) and the compound (B) are usually mixed in a solvent.

### (Production of Imino Group by Reaction of Compound (A) and Compound (B))

A resin composition in accordance with an embodiment of the present invention is a mixture of a compound (A) having a benzoxazine ring and an aldehyde group and an aromatic amine compound (B). In this mixture, an imino group may be produced by dehydration condensation reaction of an aldehyde group in the compound (A) and an amino group in the compound (B). The resin composition in accordance with an embodiment of the present invention contains an aldehyde group in an amount of not less than 50 mol %, where 100 mol % represents a total amount of the aldehyde group and an imino group in the resin composition. In an embodiment of the present invention, the resin composition contains the aldehyde group in an amount of preferably not less than 55 mol %, more preferably not less than 60 mol %, and even more preferably not less than 70 mol %, where 100 mol& represents a total amount of the aldehyde group and the imino group in the resin composition. Note that the resin composition in accordance with an embodiment of the present invention may be a resin composition which contains the aldehyde group in an amount of 100 mol % and contains the imino group in an amount of 0 mol %. A resin composition which contains an aldehyde group in a large amount has low viscosity and thus, for example, facilitates an operation carried out to impregnate reinforcement fibers with the resin composition.

### (Amount of Imino Group in Resin Composition)

The resin composition in accordance with an embodiment of the present invention is a resin composition that eventually provides a cured product by, for example, a reaction in which the benzoxazine ring is cleaved. In an embodiment of the present invention, it is desirable to have an increased amount of an imino group in the resin composition at a stage immediately before a curing reaction of the benzoxazine ring occurs. That is, it is desirable that the imino group production reaction by dehydration condensation proceed and result in a resin composition in which the imino group is present in a large amount. The amount of the imino group in the resin composition before the curing reaction of the benzoxazine ring occurs is preferably more than 50 mol %, more preferably not less than 70 mol %, even more preferably not less than 80 mol %, and particularly preferably not less than 90 mol %, where 100 mol % represents a total amount of the aldehyde group and the imino group in the resin composition.

Embodiments of the present invention also encompass a method for producing a resin composition in which an imino group is present in a large amount, the method including the step of heating a resin composition in a solution state until the amount of an imino group in the resin composition becomes more than 50 mol %, where 100 mol % represents a total amount of an aldehyde group and the imino group in the resin composition.

In addition, embodiments of the present invention also encompass a method for producing a resin composition in which an imino group is present in a large amount, the method including the step of heating a resin composition in a solid state until the amount of an imino group in the resin composition becomes not less than 70 mol %, where 100 mol % represents a total amount of an aldehyde group and the imino group in the resin composition.

### (Solvent in Resin Composition)

A resin composition in accordance with an embodiment of the present invention is usually a resin composition containing a solvent, but may be a resin composition containing no solvent. In the present specification, a resin composition containing a solvent may also be expressed as varnish.

Examples of the solvent contained in the resin composition in accordance with an embodiment of the present invention include: halogen-based solvents such as chloroform; non-halogen-based aromatic hydrocarbon solvents such as toluene and xylene; ether-based solvents such as tetrahydrofuran (THF); cyclic diether-based solvents such as 1,4-dioxane and 1,3-dioxolane; high polarity and high boiling point solvents such as N,N-dimethylformamide (DMF), N,N-dimethylacetamide, N-methyl-2-pyrrolidone (NMP), N,N-diethylacetamide, N-methylcaprolactam, γ-butyrolactone, and dimethyl sulfoxide; and mixed solvents of non-halogen-based hydrocarbon solvents and aliphatic alcohol-based solvents. Examples of the aliphatic alcohol-based solvents include methanol, ethanol, propanol, and butanol (including structural isomers). From the viewpoint of suppression of a side reaction, it is preferable to use a non-halogen-based aromatic hydrocarbon solvent.

The amount of the solvent contained in the resin composition in accordance with an embodiment of the present invention is not limited in particular, but is usually not less than 0% by weight and not more than 95% by weight, preferably not less than 0% by weight and not more than 68% by weight, more preferably not less than 10% by weight and not more than 67% by weight, and even more preferably not less than 20% by weight and not more than 65% by weight, in the resin composition.

### (Reinforcement Fibers)

A resin composition in accordance with an embodiment of the present invention may further contain reinforcement fibers. Impregnating reinforcement fibers with a resin composition may cause the resin composition to contain the reinforcement fibers. Examples of the reinforcement fibers in accordance with an embodiment of the present invention include inorganic fibers, organic fibers, metal fibers, and hybrid reinforcement fibers which are obtained by combining any of these fibers. One type or two or more types of reinforcement fibers may be used.

Example of the inorganic fibers include carbon fibers, graphite fibers, silicon carbide fibers, alumina fibers, tungsten carbide fibers, boron fibers, and glass fibers. Example of the organic fibers include aramid fibers, high-density polyethylene fibers, the other general nylon fibers, and polyester fibers. Examples of the metal fibers include fibers of stainless steel, iron, and the like. Examples of the metal fibers also include carbon-coated metal fibers in which metal fibers are coated with carbon. In particular, the reinforcement fibers are preferably carbon fibers, from the viewpoint of an increase in strength of the cured product.

In general, the carbon fibers are subjected to sizing. The carbon fibers may be used as they are. As necessary, the fibers for which a small amount of a sizing agent is used can be used, or the sizing agent can be removed by an existing method such as an organic solvent treatment or a heat treatment. The carbon fibers may be subjected to a process in which a carbon fiber bundle is opened in advance with use of air, a roller, or the like so that the resin is easily impregnated between individual carbon fibers.

### (Other Components)

A resin composition in accordance with an embodiment of the present invention contains the compound (A) and the compound (B) as main components, and may contain another thermosetting resin, a thermoplastic resin, and a compounding agent as accessory components.

Examples of the another thermosetting resin include epoxy-based resins, thermosetting type modified polyphenylene ether resins, thermosetting polyimide resins, silicon resins, melamine resins, urea resins, allyl resins, phenol resins, unsaturated polyester resins, bismaleimide-based resins, alkyd resins, furan resins, polyurethane resins, and aniline resins.

Examples of the thermoplastic resin include thermoplastic epoxy resins and thermoplastic polyimide resins.

Examples of the compounding agent include, as necessary, flame retardants, nucleating agents, antioxidants, anti-aging agents, thermal stabilizers, photo stabilizers, ultraviolet absorbers, lubricants, auxiliary flame retardants, antistatic agents, anti-fogging agents, fillers, softeners, plasticizers, and coloring agents. Each of these agents may be used alone, or two or more of these agents may be used in combination. A reactive or non-reactive solvent can also be used.

### [4. Prepreg]

Embodiments of the present invention also encompass a prepreg which is obtained by use of the resin composition containing the above-described reinforcement fibers.

### (Method for Producing Prepreg)

A prepreg in accordance with an embodiment of the present invention is produced by a production method including a step of mixing, with reinforcement fibers, a resin composition containing a compound (A) having a benzoxazine ring and an aldehyde group and an aromatic amine compound (B). In other words, the prepreg in accordance with an embodiment of the present invention is produced by impregnating reinforcement fibers with a composition containing a compound (A) having a benzoxazine ring and an aldehyde group and an aromatic amine compound (B). Usually, the prepreg in accordance with an embodiment of the present invention can be produced by impregnating reinforcement fibers with a mixture (referred to as varnish by a person skilled in the art) of the compound (A), and the compound (B), and a solvent.

In the resin composition, the aldehyde group is contained in an amount of not less than 50 mol %, where 100 mol % represents a total amount of the aldehyde group and an imino group in the resin composition. Further, it is preferable that the resin composition contain the solvent in an amount of not more than 68% by weight.

A method for producing a prepreg in accordance with an embodiment of the present invention is preferably a method including the following steps:
Step 1. Produce a mixture containing a compound (A) having a benzoxazine ring and an aldehyde group, an aromatic amine compound (B), and a solvent.
Step 2. Impregnate reinforcement fibers with the mixture obtained in step 1.

### [5. Curing Reaction of Benzoxazine Ring]

A resin composition in accordance with an embodiment of the present invention is a resin composition that contains a benzoxazine ring derived from the compound (A). It is possible to provide a cured product in a case where this benzoxazine ring undergoes ring opening polymerization and/or a reaction with another compound by heat or the like. In a case where the resin composition in accordance with an embodiment of the present invention contains reinforcement fibers, it is possible to provide a fiber reinforced composite material. In the present specification, the “fiber reinforced composite material” is also referred to as “fiber composite material”.

A final heat treatment temperature necessary to fully cure the resin composition in accordance with an embodiment of the present invention is usually not lower than 150° C., and a curing reaction temperature is preferably not lower than 180° C., and more preferably not lower than 220° C. Here, the expression “fully cure” may include not only a state in which all benzoxazine rings have reacted, but also a state in which the benzoxazine rings have reacted to such an extent that the cured resin composition can have a tolerance for use as a molded product. In order to prevent thermal decomposition of the resin composition during the curing reaction, it is preferable to carry out the curing reaction at a temperature of not higher than 260° C.

### [6. Method for Producing Fiber Composite Material]

### (Fiber Composite Material)

A fiber composite material can be obtained by impregnating reinforcement fibers with the resin composition in accordance with an embodiment of the present invention. Further, a fiber composite material can also be obtained by curing the prepreg in accordance with an embodiment of the present invention.

### (Carbon Fiber Composite Material)

In a case where the reinforcement fibers in the prepreg in accordance with an embodiment of the present invention are carbon fibers, a carbon fiber composite material can be obtained by use of the prepreg.

The carbon fiber composite material is also referred to as “carbon fiber reinforced plastic (CFRP)”. A method for preparing the carbon fiber composite material is not limited in particular, and may be, for example, a method in which a prepreg which is a sheet obtained by impregnating carbon fibers with the resin is used or a method in which the carbon fibers (in bundled form or fabric form) are impregnated with the resin in liquid form.

Note that the carbon fiber composite material is described here as an example, but, as stated above, reinforcement fibers which can be used are not limited to the carbon fibers. The reaction is preferably carried out at a temperature of not higher than 260° C.

### (Production Method)

Embodiments of the present invention also encompass a method for producing a fiber composite material which is obtained by curing the prepreg. The method for producing the fiber composite material is not limited in particular. The fiber composite material can be produced by a method including the step of producing the prepreg and then heating the prepreg to a temperature of not lower than 150° C. That is, the fiber composite material can be produced by a method including: the step of producing the prepreg by the above-described method; and the step of heating the prepreg to a temperature of not lower than 150° C. A temperature at which the prepreg is heated is not lower than 150° C., preferably not lower than 180° C., and more preferably not lower than 220° C. The temperature at which the prepreg is heated may be, for example, not higher than 300° C.

The method for producing the fiber composite material may include, for example, the steps of: obtaining a preliminarily cured prepreg having a degree of cure of more than 0% to 99% by preliminarily curing the prepreg; and obtaining the fiber composite material by curing the preliminarily cured prepreg. Note, here, that, in the present specification, preliminarily curing means partially curing the prepreg.

The degree of cure of the preliminarily cured prepreg may be not more than 99%, preferably not more than 90%, and more preferably not more than 80%.

Although the fiber composite material which is obtained with use of only the prepreg in accordance with the present invention is described here as an example, the prepreg in accordance with the present invention and a prepreg obtained by impregnating reinforcement fibers with another resin or a composition of the another resin may be stacked together to obtain the fiber composite material. The another resin is not limited in particular, and examples thereof include the another thermosetting resin and the thermoplastic resin described in [2. Resin composition]. The composition of the another resin contains the another resin as a main component, and may further contain, for example, the another thermosetting resin (except the another resin), the thermoplastic resin (except the another resin), and the compounding agent described in [2. Resin composition]. That is, the embodiments of the present invention also include a fiber composite material obtained by integrating (i) the fiber composite material which is obtained by impregnating the reinforcement fibers with the foregoing resin composition and curing the resin composition and (ii) a fiber composite material obtained by impregnating the reinforcement fibers with the another resin or the composition of the another resin, to such a degree that these fiber composite materials cannot be separated.

### [7. Method for Producing Cured Product]

Embodiments of the present invention also encompass a method for producing a cured product, the method including the step of producing a resin composition and then heating the resin composition to a temperature of not lower than 150° C. That is, the production method includes a step of obtaining a resin composition and a step of heating the obtained resin composition to a temperature of not lower than 150° C. The temperature at which the resin composition is heated to obtain the cured product may be not lower than 150° C., may be not lower than 180° C., or may be not lower than 220° C.

### (Properties of Cured Product)

A prepreg or a cured product each of which is obtained by use of the resin composition in accordance with an embodiment of the present invention is the one that exhibits a variety of excellent properties which are similar to those described in Patent Literature 2 (WO2023/204169) listed above. There may be a case where the prepreg in accordance with an embodiment of the present invention is capable of being cured in a free-standing state. Note, here, that, in the present specification, the “free-standing state” refers to a state in which a free-standing shape is maintained. Note also that the “free-standing shape” refers to an arbitrary shape which is desired to be imparted after molding and which does not need a physical support, for example, a curved shape.

In the present specification, the property in which the prepreg is capable of being cured in a free-standing state refers to a property in which, in a case where a laminate which includes the prepreg having an arbitrary shape that is desired to be imparted after molding, for example, a curved shape is heated with use of an oven or the like, the shape (free-standing shape) is maintained even after the heating without the need for a physical support. Note, here, that the laminate including the prepreg is also expressed as a prepreg laminate. Specifically, the property is a property in which, in a case where the prepreg laminate is heated with use of an oven or the like in a state in which one end of the prepreg laminate is fixed to a main surface of an object having a planar surface and the other end of the prepreg laminate is caused to float in the air, the shape before the heating (for example, a curved shape) is maintained even after the heating.

Since the prepreg has the free-standing property, it is possible to switch from molding with use of an autoclave to molding with use of an oven, in the middle of molding the composite material. In the molding with use of an oven, unlike the molding with use of an autoclave, it is possible to use a general-purpose subsidiary material (heat resistance is approximately 180° C. in accordance with an epoxy). Therefore, it is preferable that the prepreg have the free-standing property because this makes it is possible to mold the composite material without the need for an expensive subsidiary material.

In addition, there may be a case where a cured product in accordance with an embodiment of the present invention provides a decomposition product which is obtained by decomposing the cured product under an acidic or basic condition and which is soluble in a solvent. In addition, there may be a case where the decomposition product can be recovered and reused. For example, by drying a decomposition solution (acidic or basic solution containing the decomposition product) or by mixing the decomposition solution with a poor solvent and precipitating and obtaining the solid content, the decomposition product can be recovered from the solvent. Subsequently, the cured product can also be obtained again by reacting the recovered decomposition product.

In a case where the cured product contains the reinforcement fibers, both the decomposition product and the reinforcement fibers can be recovered and reused. Specifically, the decomposition the product and reinforcement fibers are first separated by filtration, centrifugation, or the like, and then recovered. Thereafter, by drying the decomposition solution containing the decomposition product or by mixing the decomposition solution with a poor solvent and precipitating and obtaining the solid content, the decomposition product can be recovered from the solvent. Furthermore, by mixing the recovered decomposition product and the reinforcement fibers and reacting the decomposition product, the cured product containing the reinforcement fibers can also be obtained again.

According to the configuration as described above, the cured product can be decomposed and reused. This can contribute to ensuring sustainable consumption and production patterns. Therefore, it is possible to contribute to achieving and realizing, for example, Goal 12 “responsible consumption and production” of the Sustainable Development Goals (SDGs).

### [8. Method for Decomposing Fiber Composite Material and Cured Product]

The fiber composite material can be decomposed under an acidic or basic condition. Embodiments of the present invention encompass a method for decomposing a fiber composite material that has been obtained by the above-described production method, the method including the step of decomposing the fiber composite material under an acidic or basic condition.

Note, here, that the decomposition under the acidic condition is solvolysis. Examples of the decomposition under the basic condition include decomposition in which a basic substance is added to the imino group so that the imino group undergoes a cleavage reaction or a bond exchange reaction. By decomposing a fiber composite material under the acidic or basic condition, it is possible to cleave the imine bond in the fiber composite material and possible to obtain the decomposition product. In the present specification, the solvolysis means cleaving the imine bond by a reaction between a solvent molecule and the imine bond to obtain the decomposition product.

Examples of a method for subjecting the fiber composite material to the solvolysis under the acidic condition include a method in which the fiber composite material is brought into contact with an acidic solution containing an acid and a solvent. Examples of the solvent in the acidic solution include water, tetrahydrofuran (THF), and a mixed solvent thereof. Examples of the acid include acetic acid, hydrochloric acid, nitric acid, and sulfuric acid.

Examples of a method for decomposing the fiber composite material under the basic condition include a method in which the fiber composite material is brought into contact with an amine compound. The amine compound is not limited in particular, and examples thereof include: aromatic monoamines such as aniline; aromatic diamines such as p-phenylenediamine, 1,3-bis(4-aminophenoxy)benzene (RODA), and 4,4′-isopropylidene bis[(4-aminophenoxy)benzene] (BAPP); aliphatic monoamines such as methylamine, ethylamine, and butylamine; and aliphatic diamines such as ethylenediamine, trimethylenediamine, tetramethylenediamine, pentamethylenediamine, hexamethylenediamine, and m-xylene-α,α′-diamine (mXDA).

In the decomposition step, heating may be carried out. A heating temperature may be, for example, 40° C. to 180° C. A heating time may be 5 minutes to 350 hours. In the decomposition step, stirring may be carried out as necessary.

A cured product that is obtained by curing the resin composition can also be decomposed under an acidic or basic condition. Embodiments of the present invention encompass a method for decomposing the cured product, the method including the step of decomposing the cured product under an acidic or basic condition. Note, here, that the cured product may be obtained by curing a resin composition in a prepreg that has been obtained by the above-described “method for producing a prepreg”. The decomposition under an acidic c condition and the decomposition under a basic condition are the same as above-described decompositions of the fiber the composite material, and descriptions thereof are omitted here.

### [9. Cured Molded Product]

A cured molded product can be obtained by curing and molding the resin composition in accordance with an embodiment of the present invention. In the present specification, the cured molded product is intended to be a molded product having a degree of cure of 1% to 100%. That is, the cured molded product also encompasses a molded product which is cured only partially. The degree of cure can be calculated from a ratio between the area of an exothermic peak obtained from a DSC curve of an uncured resin and the area of an exothermic peak obtained from a DSC curve of the uncured molded product or the cured molded product, as described in Examples below. Note, here, that the uncured molded product is intended to be a molded product having a degree of cure of less than 1%.

The dimensions and shape of the cured molded product are not limited in particular. For example, the cured molded product has a film shape, a sheet shape, a plate shape, a block shape, or the like. The cured molded product may include another layer (for example, an adhesive layer), in addition to a layer made of the above-described resin composition.

From the viewpoint of heat resistance, the glass transition temperature of the cured molded product is preferably not lower than 150° C., more preferably not lower than 200° C., and even more preferably not lower than 220° C. The upper limit of the glass transition temperature of the cured molded product is not limited in particular, but can be, for example, not higher than 400° C.

The thermal stability of the cured molded product can be evaluated by a 5% weight reduction temperature (Td5). The 5% weight reduction temperature of the cured molded product is preferably not lower than 250° C., more preferably not lower than 300° C., and even more preferably not lower than 320° C.

From the viewpoint of the mechanical properties, the tensile modulus of the cured molded product is preferably not more than 10 GPa, more preferably not more than 8 GPa, and even more preferably not more than 5 GPa. From the viewpoint of ease of handling, the tensile modulus of the cured molded product is preferably not less than 0.1 GPa, more preferably not less than 0.5 GPa, and even more preferably not less than 1 GPa.

From the viewpoint of unlikeness of break, the tensile breaking strength of the cured molded product is preferably not less than 5 MPa, more preferably not less than 10 MPa, and even more preferably not less than 50 MPa.

From the viewpoint of the mechanical properties, the tensile elongation at break of the cured molded product is preferably not less than 1%, more preferably not less than 3%, and even more preferably not less than 5%.

A method for molding the cured molded product is not limited in particular, and examples thereof include: a method in which a solution obtained by dissolving the above-described resin composition in a solvent is casted on a base material and molded (casting method); and a method in which the above-described resin composition is pressed and molded (pressing method). Examples of the solvent used in the casting method include N,N-dimethyl formamide (DMF), tetrahydrofuran (THF), chloroform, N,N-dimethylacetamide, N-methyl-2-pyrrolidone, N,N-diethylacetamide, N-methylcaprolactam, γ-butyrolactone, cyclohexanone, dimethyl sulfoxide, cyclopentanone, 1,4-dioxane, and 1,3-dioxolane. A pressure in the pressing method is not limited in particular, and may be, for example, 0.1 MPa to 5.0 MPa.

A curing temperature of the cured molded product (the maximum temperature in a case where the curing temperature is increased gradually) is not limited in particular, but is preferably 200° C. to 300° C., more preferably 210° C. to 280° C., and even more preferably 220° C. to 260° C.

The cured molded product may contain reinforcement fibers from the viewpoint of improving mechanical strength of the cured molded product. As the reinforcement fibers, for example, the same reinforcement fibers as the reinforcement fibers that can be contained in the above-described resin composition can be used. In addition, the cured molded product can be used as a fiber composite material. The above-described cured molded product may be molded into a prepreg, and the prepreg may be used to prepare the fiber composite material.

The present invention is not limited to the embodiments, but can be altered by a skilled person in the art within the scope of the claims. The present invention also encompasses, in its technical scope, any embodiment derived by combining technical means disclosed in differing embodiments.

### SUMMARY

As a result of the studies conducted by the inventors of the present invention, it has become possible to produce a prepreg in a more advantageous process by impregnating, with reinforcement fibers, “a mixture which is a mixture of a compound (A) having a benzoxazine ring and an aldehyde group and an aromatic amine compound (B) and which has the aldehyde group in a predetermined amount”.

That is, embodiments of the present invention are as follows.

<1> A method for producing a prepreg, the method including the step of mixing, with reinforcement fibers, a resin composition containing a compound (A) having a benzoxazine ring and an aldehyde group and an aromatic amine compound (B), wherein
the resin composition contains the aldehyde group in an amount of not less than 50 mol %, where 100 mol % represents a total amount of the aldehyde group and an imino group in the resin composition.

<2> The method described in <1>, wherein the resin composition is a resin composition in a solution state.

<3> The method described in <2>, wherein the resin composition contains a solvent in an amount of not more than 68% by weight.

<4> The method described in any one of <1> to <3>, wherein the compound (A) has two to five aldehyde groups, and the compound (B) has two to five amino groups.

<5> The method described in any one of <1> to <4>, wherein the compound (A) is a compound represented by the following general formula (I):

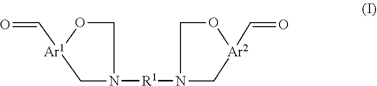

where: Ar¹ and Ar² each represent a trivalent aromatic group derived from a phenol compound, Ar¹ and Ar² may be identical to or different from each other, and R¹ represents a divalent aromatic group; and Ar¹, Ar², and R¹ each do not have a C═N group.

<6> The method described in any one of <1> to <5>, wherein the aromatic amine compound (B) is at least one compound selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminodiphenylmethane, 4,4′-diaminodiphenylether, 4,4′-diaminobenzophenone, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy) biphenyl, 4,4′-bis(4-aminophenoxy) biphenyl, and 9,9-bis(4-aminophenyl) fluorene.

<7> A method for producing a fiber composite material, the method including the step of producing a prepreg by a production method described in any one of <1> to <6> and then heating the prepreg to a temperature of not lower than 150° C.

<8> A resin composition containing: a compound (A) having a benzoxazine ring and an aldehyde group; and an aromatic amine compound (B), wherein the resin composition contains the aldehyde group in an amount of not less than 50 mol %, where 100 mol % represents a total amount of the aldehyde group and an imino group in the resin composition, and the resin composition contains a solvent in an amount of not less than 0% by weight and not more than 68% by weight.

<9> The resin composition described in <8>, wherein the compound (A) has two to five aldehyde groups, and the compound (B) has two to five amino groups.

<10> The resin composition described in <8> or <9>, wherein the compound (A) is a compound represented by the following general formula (I):

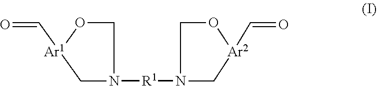

where: Ar¹ and Ar² each represent a trivalent aromatic group derived from a phenol compound, Ar¹ and Ar² may be identical to or different from each other, and R¹ represents a divalent aromatic group; and Ar¹, Ar², and R¹ each do not have a C═N group.

<11> The resin composition described in any one of <8> to <10>, wherein the aromatic amine compound (B) is at least one compound selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminodiphenylmethane, 4,4′-diaminodiphenylether, 4,4′-diaminobenzophenone, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy) biphenyl, 4,4′-bis(4-aminophenoxy) biphenyl, and 9,9-bis(4-aminophenyl) fluorene.

<12> The resin composition described in any one of <8> to <11>, wherein the resin composition contains reinforcement fibers.

<13> A prepreg consisting of a resin composition described in <12>.

<14> A method for producing a resin composition in which an imino group is present in a large amount, the method including the step of heating a resin composition described in any one of <8> to <12> which is in a solution state until the amount of the imino group in the resin composition becomes more than 50 mol %, where 100 mol % represents a total amount of an aldehyde group and the imino group in the resin composition.

<15> A method for producing a resin composition in which an imino group is present in a large amount, the method including the step of heating a resin composition described in any one of <8> to <12> which is in a solid state until the amount of the imino group in the resin composition becomes not less than 70 mol %, where 100 mol % represents a total amount of an aldehyde group and the imino group in the resin composition.

<16> A method for producing a cured product, the method including the step of producing a resin composition described in any one of <8> to <12> or a resin composition described in <14> or <15> in which an imino group is present in a large amount and then heating the resin composition to a temperature of not lower than 150° C.

<17> A method for producing a fiber composite material, the method including the step of producing a prepreg described in <13> and then heating the prepreg to a temperature of not lower than 150° C.

<18> A method for decomposing a cured product that is obtained by curing a resin composition in a prepreg which has been obtained by a production method described in any one of <1> to <6>, the method including the step of decomposing the cured product under an acidic or basic condition.

<19> A method for decomposing a fiber composite material that has been obtained by a production method described in <7> or <17>, the method including the step of decomposing the fiber composite material under an acidic or basic condition.

<20> A method for decomposing a cured product that is obtained by curing a resin composition described in any one of <8> to <12>, the method including the step of decomposing the cured product under an acidic or basic condition.

### EXAMPLES

The following description will discuss examples of the present invention. Note that, in the following description, a cured film corresponds to a cured molded product.

### [Test Methods]

### <Analysis of Structure of Benzoxazine Compound>

The molecular structure of a benzoxazine compound was analyzed. Specifically, ¹H-NMR measurement was carried out with use of a nuclei magnetic resonance device (NMR, AVANCE III 400 MHZ, manufactured by Bruker) under the condition that the number of times of accumulation was 16 and a measurement temperature was room temperature.

### <GPC Measurement 1 of Benzoxazine Compound>

The molecular weight of the benzoxazine compound was measured with use of a gel permeation chromatograph (GPC) (Prominence UFLC manufactured by Shimadzu Corporation). In the measurement, 0.01 mol/L of lithium chloride-containing DMF was used as a mobile phase, three TSKgel GMHHR-M columns manufactured by Tosoh Corporation were connected in series and used as columns, a flow rate was 1 mL/min, an injection volume was 20 μL, a column temperature was 40° C., a UV detector was used for detection, and polystyrene was used as a sample for a calibration curve.

### <GPC Measurement 2 of Benzoxazine Compound>

The molecular weight of the benzoxazine compound was measured with use of a GPC (HLC-8320GPC manufactured by Tosoh Corporation). In the measurement, chloroform was used as a mobile phase, and a TSKgel SuperHM-N column manufactured by Tosoh Corporation was used as a column. A UV detector was used for detection, and polystyrene was used as a sample for a calibration curve.

### <Curing Onset Temperature, Curing Exothermic Peak Top, and Amount of Generated Heat>

DSC curves were measured with use of a differential scanning calorimeter (DSC, DSC7000X manufactured by Hitachi High-Tech Science Corporation) at 5° C./min and a nitrogen flow rate of 40 mL/min. Next, the degree of cure was calculated from the amounts of heat generated before and after curing derived from ring opening of benzoxazine, with use of the following formula.

$$The degree of cure [ \% ] = 100 - \{ ( the amount of the heat generated after the curing ) / ( the amount of the heat generated before the curing ) \times 100 \}$$

Note, here, that the amount of the heat generated before the curing indicates the area of an exothermic peak in the DSC curve of an uncured resin, and the amount of the heat generated after the curing indicates the area of an exothermic peak in the DSC curve of the cured film.

### <Glass Transition Temperature (Tg) of Cured Film>

The Tg of each of an uncured film and the cured film was measured with use of a dynamic viscoelasticity measurement device (DMA, RSA G2, manufactured by TA Instruments, tension mode) at a frequency (1 Hz) and a temperature increase rate of 5° C./min. An extrapolated glass transition onset temperature (an intersection of a straight line obtained by extending, to a higher temperature region by extrapolation, a baseline before an inflection point and a tangent line at the inflection point) determined from an obtained DMA curve was regarded as the Tg in the present Examples.

### <Infrared Absorption Spectrum (IR) Measurement>

Infrared absorption spectrum measurement was carried out with use of IRAffinity-1 manufactured by Shimadzu Corporation under the conditions of room temperature, a range of 600 cm⁻¹ to 4000 cm⁻¹, and 32 times of accumulation.

### <Melt Viscosity Measurement>

With use of a rheometer (type: ARES-G2 model, manufactured by TA Instruments), the sample which was sandwiched between 25-mm parallel plates was subjected to measurement at a temperature increase rate of 2° C./min.

### <Glass Transition Temperature (Tg) of Fiber Reinforced Composite Material>

The Tg of an uncured film and the Tg of a cured film were measured with use of a dynamic viscoelasticity measurement device (DMA, DMA Q850, manufactured by TA Instruments, single cantilever mode) under the conditions of a frequency of 1 Hz and a temperature increase rate of 5° C./min. An extrapolated glass transition onset temperature (an intersection of straight line obtained by extending, to a higher temperature region by extrapolation, a baseline before an inflection point and a tangent line at the inflection point) determined from an obtained DMA curve was regarded as the Tg in the present Examples.

### <Decomposability Evaluation 1 of Cured Film>

The cured film and hexamethylenediamine were added to each of various types of organic solvents, and then a resulting solution was heated and stirred. A state after the heating and stirring was observed, and decomposability was evaluated in accordance with the following criteria.
A: The cured film was dissolved (it was evaluated that the cured film exhibited decomposability).
B: The cured film was not dissolved (it was evaluated that the cured film did not exhibit decomposability).

### <Decomposability Evaluation 2 of Cured Film>

The cured film was added to a 2M HCl aqueous solution/THF (1/3, v/v), and then a resulting solution was heated and stirred at 55° C. A state after the heating and stirring was observed, and decomposability was evaluated in accordance with the following criteria.
A: The cured film was dissolved (it was evaluated that the cured film exhibited decomposability).
B: The cured film was not dissolved (it was evaluated that the cured film did not exhibit decomposability).

### [Materials]

Materials used to produce the imino group-containing benzoxazine compound are shown below.

### (Phenol Compound Having Aldehyde Group)

4-hydroxybenzaldehyde (manufactured by FUJIFILM Wako Pure Chemical Corporation)

### (Aromatic Diamine Compound)

4,4′-diaminodiphenylether (manufactured by Seika Corporation).
   2,2-bis[4-(4-aminophenoxy)phenyl]propane (manufactured by Seika Corporation)

### (Other Compound)

Paraformaldehyde (manufactured by FUJIFILM Wako Pure Chemical Corporation)

A material used in the decomposability evaluation 1 of the benzoxazine compound is shown below.

### (Amine Compound)

Hexamethylenediamine (manufactured by Toray Industries, Inc.)

### <Production of Aldehyde Group-Containing Benzoxazine Compound>

### Production Example 1

To a reaction container equipped with a stirrer, 4,4′-diaminodiphenylether (58.4692 g, 0.2000 mol), paraformaldehyde (25.2302 g, 0.8402 mol), 4-hydroxybenzaldehyde (48.8505 g, 0.4000 mol), and toluene (174.0641 g) were added. These were reacted for 6 hours, while being refluxed. After an obtained reaction solution (A) was cooled to room temperature, the reaction solution (A) was dripped in stirred hexane (600 mL), so that a viscous precipitate was obtained. After a supernatant was removed, the obtained precipitate was dried at 110° C. under reduced pressure for 15 hours with use of a vacuum dryer to obtain an aldehyde group-containing benzoxazine compound (a). The molecular weight of the obtained aldehyde group-containing benzoxazine compound (a) was measured by GPC measurement. As a result, the aldehyde group-containing benzoxazine compound (a) had a weight average molecular weight (Mw) of 1168 and a number average molecular weight (Mn) of 927. By ¹H-NMR measurement (deuterated solvent was DMSO-d₆), a decrease in peak of an aldehyde group of 4-hydroxybenzaldehyde at 9.8 ppm and generation of peaks of a benzoxazine ring at 4.7 ppm and 5.5 ppm were observed. It was confirmed from the former that the raw materials were consumed, and it was confirmed from the latter that the benzoxazine compound (a) could be synthesized.

### <Mixing 1 of Raw Materials for Imino Group-Containing Benzoxazine Compound>

### Production Example 2

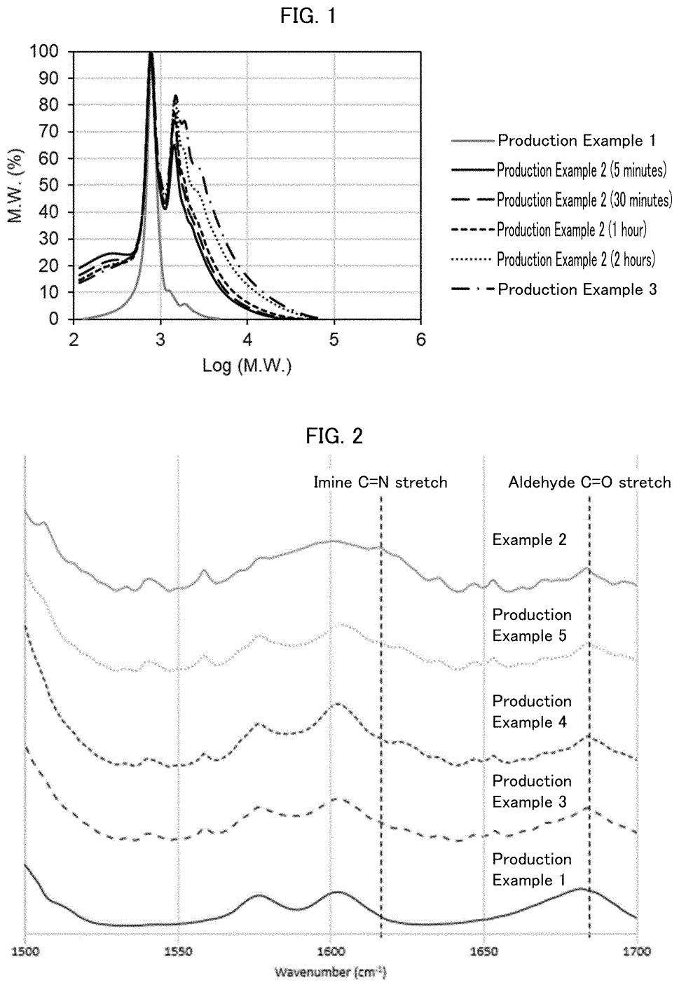

To a reaction container equipped with a stirrer, the obtained benzoxazine compound (a) (7.01 g, 0.0142 mol), 2,2-bis[4-(4-aminophenoxy)phenyl]propane (4.11 g, 0.0100 mol), 1,3-dioxolane (13.58 g) were added. A resulting mixture was stirred at room temperature for 5 minutes to 2 hours. By ¹H-NMR measurement (deuterated solvent was DMSO-d₆), a decrease in peak of an aldehyde terminal (raw material) at 9.8 ppm and generation of a peak of an imino group (product) at 8.5 ppm were observed with the passage of time. However, it was confirmed that the raw material was not sufficiently reacted in this time range. Table 1 shows the progression of an integral value of each peak in a case where an integral value of benzoxazine at 5.5 ppm was assumed to be 1. By GPC measurement using 0.01 mol/L lithium chloride-containing DMF as a mobile phase, a plurality of peaks were observed on a side corresponding to a molecular weight that is higher than the molecular weight of aldehyde group-containing benzoxazine which is the raw material, and it was confirmed that imino group-containing benzoxazine monomers (monomers) and oligomers (dimers and trimers) increased with the passage of time. A GPC chart is shown in FIG. 1.

TABLE 1

| | | Integral | Integral | | |
|---|---|---|---|---|---|
| | | value of ¹H | value of ¹H | Amount of | Amount of |
| | | peak of | peak of | aldehyde | imino |
| Stirring | | aldehyde | imino | group | group |
| time | | group | group | (mol %) | (mol %) |
| 5 | minutes | 0.41 | 0.17 | 71 | 29 |
| 30 | minutes | 0.36 | 0.21 | 63 | 37 |
| 1 | hour | 0.34 | 0.24 | 59 | 41 |
| 2 | hours | 0.26 | 0.31 | 46 | 54 |

### <Drying 1 of Varnish Obtained by Mixing Raw Materials for Imino Group-Containing Benzoxazine Compound>

### Production Example 3

A varnish was prepared by mixing the raw materials for 30 minutes in Production Example 2, and 1.953 g of the varnish which was placed in an aluminum container was dried under vacuum by being heated at 30° C. in a vacuum oven. After the elapse of 1 hour, the amount of volatilization became constant to some extent, at which time the drying was finished. The weight after the drying was 1.034 g, and the solvent was volatilized by 87%. As a result of ¹H-NMR measurement (deuterated solvent was CDCl₃), in a case where an integral value of benzoxazine at 5.4 ppm was assumed to be 1, an integral value of an aldehyde terminal at 9.8 ppm was 0.26, and an integral value of an imino group at 8.3 ppm was 0.22. By GPC measurement, when compared with the GPC measurement carried out after the mixing and dissolution, a plurality of peaks were observed on a side corresponding to a molecular weight that is higher than the molecular weight of aldehyde group-containing benzoxazine which is the raw material, and it was confirmed that imino group-containing benzoxazine monomers (monomers) and oligomers (dimers and trimers) increased. A GPC chart is shown in FIG. 1. That is, it means that the reaction of imino group-containing benzoxazine is progressed by heating. As a result of IR measurement, in a case where aldehyde C═O stretch peak intensity of 1684 cm⁻¹ was assumed to be 1, imine C═N stretch peak intensity of 1614 cm⁻¹ was 0.73. An IR chart is shown in FIG. 2.

### Production Example 4

By a method similar to that in Production Example 3, 1.972 g of the varnish which was placed in an aluminum container was dried without vacuumization by being heated at 70° C. in a vacuum oven. After the elapse of 1.5 hours, the amount of volatilization became constant to some extent, at which time the drying was finished. The weight after the drying was 1.153 g, and the solvent was volatilized by 76%. As a result of ¹H-NMR measurement (deuterated solvent was CDCl₃), in a case where an integral value of benzoxazine at 5.4 ppm was assumed to be 1, an integral value of an aldehyde terminal at 9.8 ppm was 0.17, and an integral value of an imino group at 8.3 ppm was 0.39. As a result of IR measurement, in a case where aldehyde C═O stretch peak intensity of 1684 cm⁻¹ was assumed to be 1, imine C═N stretch peak intensity of 1614 cm⁻¹ was 1.01. Since a comparison with Production Example 3 showed that the amount of aldehyde was decreased, and the contained amount of an imino group was increased, it was confirmed that the reaction of imino group-containing benzoxazine was progressed by heating. An IR chart is shown in FIG. 2.

### <Heating 1 of Solid Obtained by Mixing and Drying Raw Materials for Imino Group-Containing Benzoxazine Compound>

### Production Example 5

The dried solid obtained in Production Examples 3 was further heated at 140° C. in an oven for 30 minutes. As a result of ¹H-NMR measurement (deuterated solvent was CDCl₃), in a case where an integral value of benzoxazine at 5.4 ppm was assumed to be 1, an integral value of an aldehyde terminal at 9.8 ppm was 0.15, and an integral value of an imino group at 8.3 ppm was 0.39. As a result of IR measurement, in a case where aldehyde C═O stretch peak intensity of 1684 cm⁻¹ was assumed to be 1, imine C═N stretch peak intensity of 1614 cm⁻¹ was 1.03. Since a comparison with Production Example 3 showed that the amount of aldehyde was decreased, and the contained amount of an imino group was increased, it was confirmed that the reaction of imino group-containing benzoxazine was progressed by heating. An IR chart is shown in FIG. 2. A GPC chart obtained with chloroform used as a mobile phase is shown in FIG. 4.

TABLE 2

| | Integral | Integral | | |
|---|---|---|---|---|
| | value of ¹H | value of ¹H | Amount of | Amount of |
| | peak of | peak of | aldehyde | imino |
| | aldehyde | imino | group | group |
| | group | group | (mol %) | (mol %) |
| Production | 0.26 | 0.22 | 54 | 46 |
| Example 3 | | | | |
| Production | 0.17 | 0.39 | 30 | 70 |
| Example 4 | | | | |
| Production | 0.15 | 0.39 | 28 | 72 |
| Example 5 | | | | |

### <Mixing 2 of Raw Materials for Imino Group-Containing Benzoxazine Compound and Drying 2 of Varnish>

### Production Example 6

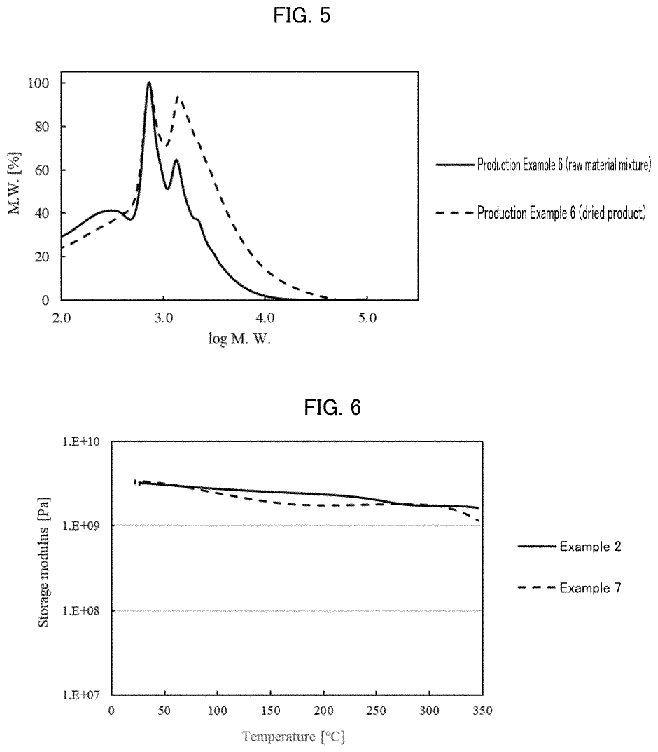

To a reaction container equipped with a stirrer, a solution A of the benzoxazine compound (a) obtained in Production Example 1 (2.00 g, 0.039 mol) and 1,3-dioxolane (3.41 g) and a solution B of 2,2-bis[4-(4-aminophenoxy)phenyl]propane (1.67 g, 0.0041 mol) and 1,3-dioxolane (2.84 g) were added. A resulting mixture was stirred at room temperature for 5 minutes. As a result of ¹H-NMR measurement (deuterated solvent was DMSO-d₆), a peak of an aldehyde terminal (raw material) at 9.8 ppm and a peak of an imino group (product) at 8.5 ppm were observed. However, it was confirmed that the raw material was not sufficiently reacted. As a result of ¹H-NMR measurement (deuterated solvent was DMSO-d₆), in a case where an integral value of benzoxazine at 5.4 ppm was assumed to be 1, an integral value of an aldehyde terminal at 9.8 ppm was 0.62, and an integral value of an imino group at 8.3 ppm was 0.04. The amount of the aldehyde group was 95 mol %, and the amount of the imino group was 5 mol %. A GPC chart obtained with 0.01 mol/L lithium chloride-containing DMF used as a mobile phase is shown in FIG. 5.

A varnish was prepared and dried under vacuum by being heated at 30° C. for 30 minutes in a vacuum oven. As a result of ¹H-NMR measurement (deuterated solvent was DMSO-d₆), in a case where an integral value of benzoxazine at 5.4 ppm was assumed to be 1, an integral value of an aldehyde terminal at 9.8 ppm was 0.31, and an integral value of an imino group at 8.3 ppm was 0.25. The amount of the aldehyde group was 55 mol %, and the amount of the imino group was 45 mol %. By GPC measurement, when compared with the GPC measurement carried out after the mixing and dissolution, a plurality of peaks were observed on a side corresponding to a molecular weight that is higher than the molecular weight of aldehyde group-containing benzoxazine which is the raw material, and it was confirmed that imino group-containing benzoxazine monomers (monomers) and oligomers (dimers and trimers) increased. A GPC chart is shown in FIG. 5. That is, it means that the reaction of imino group-containing benzoxazine is progressed by heating.

### <Curing Reaction Tracking 1 of Solid Obtained by Mixing and Drying Raw Materials for Imino Group-Containing Benzoxazine Compound>

### Example 1

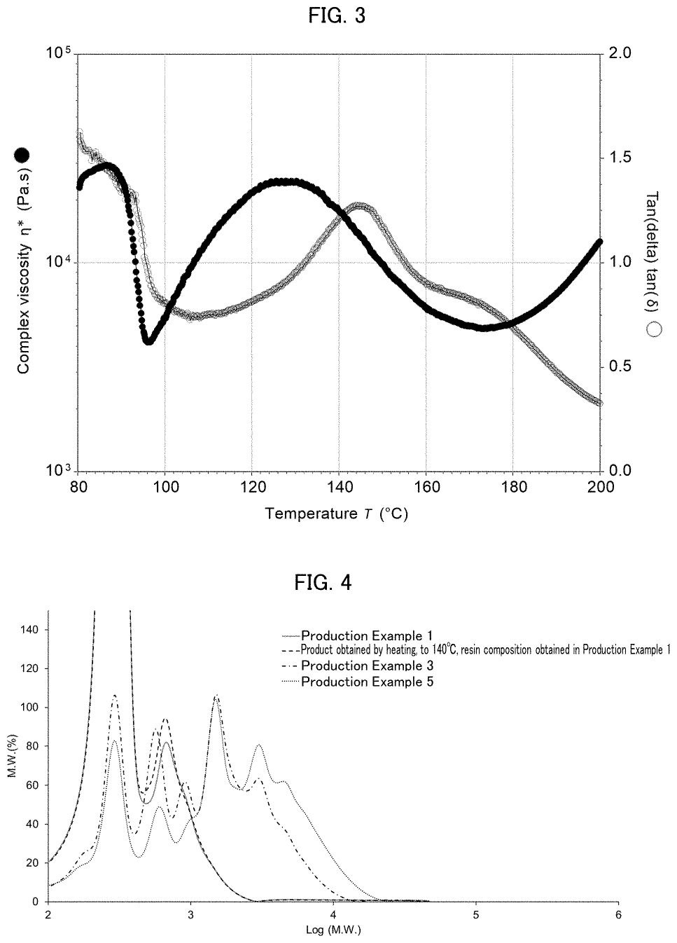

By DSC measurement of the dried solid obtained in Production Example 3, it was confirmed that a curing onset temperature was 157° C., a curing exothermic peak was 221° C., and the amount of generated heat was 159 J/g. In addition, the results of the measurement of the melt viscosity of the same solid are shown in FIG. 3. The viscosity decreased sharply at 90° C., and, at the same time, a gap between the two parallel plates for sandwiching the sample therebetween became large. After the viscosity had increased until 130° C. was reached, the viscosity decreased again. The lowest melt viscosity was reached at 170° C., and then the viscosity increased again. From the above results, behaviors in each temperature range are presumed to be exhibited as follows: At temperatures from room temperature to 100° C., it is presumed that there mainly occur melting of the raw material, volatilization of the solvent, and a reaction of imino group-containing benzoxazine; and at temperatures from 100° C. to 130° C., it is presumed that there mainly occur a reaction of the imino group-containing benzoxazine and an increase in viscosity caused by increased imino group-containing benzoxazine. In addition, at temperatures from 130° C. to 160° C., it is presumed that there mainly occurs a decrease in viscosity due to the melting of the imino group-containing benzoxazine. Furthermore, at temperatures exceeding 160° C., it is presumed that curing of the imino group-containing benzoxazine occurs mainly.

### <Curing 1 of Solid Obtained by Mixing and Drying Raw Materials for Imino Group-Containing Benzoxazine Compound>

### Example 2

On the basis of the curing behaviors in Example 1, the dried solid obtained in Production Example 3 was put in a PI film-shaped frame (4 cm×6 cm) having a thickness of 125 μm, and pressed together with a Teflon (registered trademark) sheet (release paper) and a stainless steel plate to obtain a cured film. As a pressing machine, MINI TEST PRESS-10 (manufactured by Toyo Seiki Seisaku-sho, Ltd.) was used. Processing conditions for obtaining the cured film were as follows. After melting at 100° C. for 5 minutes, pressing at an actual pressure of 6.875 MPa was carried out for 30 minutes, and then, the pressing was carried out while the temperature was increased in the following manner: 190° C. for 2 hours; and 220° C. for 1 hour. From the results of DSC measurement of this film-shaped cured product, no exothermic peak was observed, and the degree of cure was 100%. The Tg of this film-shaped cured product was 231° C. from the results of the DMA measurement. In addition, the elastic modulus at room temperature was 3.2 GPa. A DMA curve is shown in FIG. 6. As a result of IR measurement, in a case where aldehyde C═O stretch peak intensity of 1684 cm⁻¹ was assumed to be 1, imine C═N stretch peak intensity of 1614 cm⁻¹ was 1.44. Since a comparison with Production Examples 3 to 5 showed that the amount of aldehyde was further decreased, and the contained amount of an imino group was further increased, it was confirmed that the reaction of imino group-containing benzoxazine was further progressed in the process of curing heating. An IR chart is shown in FIG. 2.

TABLE 3

| | Production | Production | Production | |
|---|---|---|---|---|
| | Example 3 | Example 4 | Example 5 | Example 2 |
| 1614 cm⁻¹ | 0.73 | 1.01 | 1.03 | 1.44 |
| intensity | | | | |
| Relative ratio | 1 | 1.4 | 1.4 | 2 |

1614 cm⁻¹ intensity indicates imine stretch peak intensity of 1614 cm⁻¹ in a case where aldehyde C═O stretch peak intensity of 1684 cm⁻¹ was assumed to be 1.

### <Preparation 1 of Imino Group-Containing Benzoxazine Prepreg and CFRP>

### Example 3

A prepreg was prepared by impregnating plain weave material (weight per unit area of 195 g/m2, 15-cm square) of carbon fibers (IMS60-6K, manufactured by Teijin Limited) with a 45 wt % solution that was obtained by carrying out mixing for 30 minutes in Production Example 2. The weight of the solution contained in the prepreg was approximately 60 wt %, and the weight of the carbon fibers contained in the prepreg was approximately 40 wt %.

### Example 4

The prepreg obtained in Example 3 was dried under vacuum by being heated at 30° C. for 30 minutes in a vacuum oven.

### Example 5

Four 7.5-cm square sheets were cut out from the prepreg obtained in Examples 4 and stacked on top of each other to obtain a prepreg laminate. Next, together with a Teflon (registered trademark) sheet (release paper) and a stainless steel plate, the prepreg laminate was subjected to pressing at an actual pressure of 6.875 MPa at 100° C. for 30 minutes, and then, the pressing was carried out while the temperature was increased in the following manner: 190° C. for 2 hours and 220° C. for 1 hour. As a result, a carbon fiber-reinforced composite material (fiber composite material) was obtained. As a pressing machine, MINI TEST PRESS-10 (manufactured by Toyo Seiki Seisaku-sho, Ltd.) was used. The Tg of the obtained composite material was 231° C. from the results of the DMA measurement.

### <Curing Reaction Tracking 2 of Solid Obtained by Mixing and Drying Raw Materials for Imino Group-Containing Benzoxazine Compound>

### Example 6

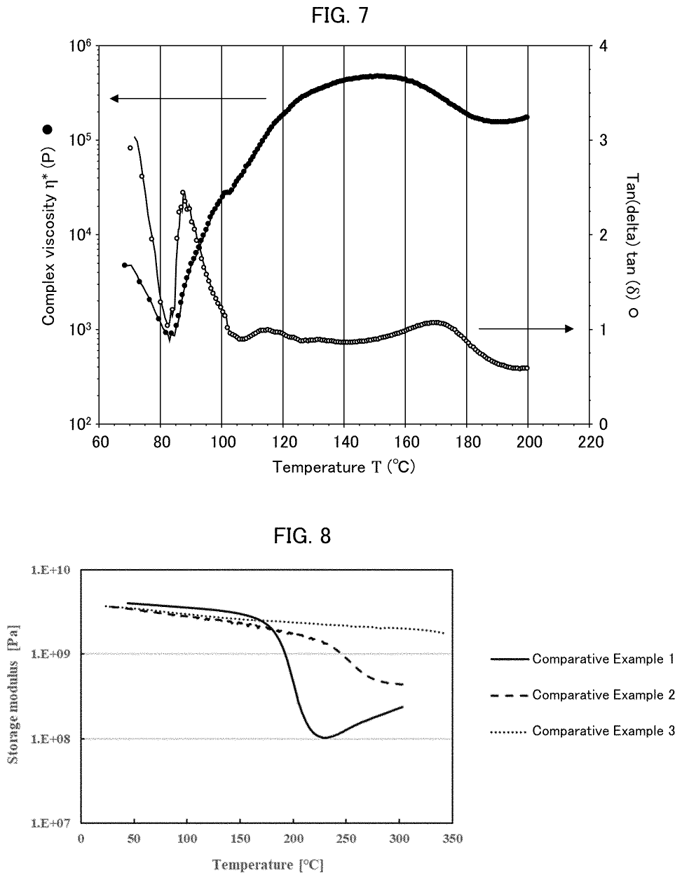

By DSC measurement of the dried solid obtained in Production Example 6, it was confirmed that a curing onset temperature was 132° C., a curing exothermic peak was 204° C., and the amount of generated heat was 150 J/g. In addition, the results of the measurement of the melt viscosity of the same solid are shown in FIG. 7. After the viscosity had decreased at 80° C., a gap between the two parallel plates for sandwiching the sample therebetween became large at 100° C. The viscosity increased until 150° C. was reached, a decrease in melt viscosity is undergone again at 190° C., and then the viscosity increased. From the above results, behaviors in each temperature range are presumed to be exhibited as follows: At temperatures from room temperature to 100° C., it is presumed that there mainly occur melting of the raw material, volatilization of the solvent, and a reaction of imino group-containing benzoxazine. In addition, at temperatures from 100° C. to 150° C., it is presumed that there mainly occur a reaction of the imino group-containing benzoxazine and an increase in viscosity caused by increased imino group-containing benzoxazine. In addition, at temperatures from 150° C. to 190° C., it is presumed that a decrease in viscosity due to the melting of the imino group-containing benzoxazine occurs mainly. Furthermore, at temperatures exceeding 190° C., it is presumed that curing of the imino group-containing benzoxazine occurs mainly.

### <Curing 2 of Solid Obtained by Mixing and Drying Raw Materials for Imino Group-Containing Benzoxazine Compound>

### Example 7

On the basis of the curing behaviors in Example 6, the dried solid obtained in Production Example 6 was put in a PI film-shaped frame (4 cm×6 cm) having a thickness of 125 μm, and pressed together with a Teflon (registered trademark) sheet (release paper) and a stainless steel plate to obtain a cured film. As a pressing machine, AYSR-10 (manufactured by Shinto Metal Industries, Ltd.) was used. Processing conditions for obtaining the cured film were as follows. Melting was carried out at 90° C. for 1 minute, and then, the temperature was increased, and pressing at an actual pressure of 3.2 MPa was carried out at 220° C. for 1 hour. From the results of DSC measurement of this film-shaped cured product, no exothermic peak was observed, and the degree of cure was 100%. The Tg of this film-shaped cured product was 316° C. from the results of the DMA measurement. In addition, the elastic modulus at room temperature was 3.4 GPa. A DMA curve is shown in FIG. 6.

### Comparative Example 1

A publicly known benzoxazine compound, which is 3,3′-(methylene-1,4-diphenylene) bis(3,4-dihydro-2H-1,3-benzoxazine) (P-d) (manufactured by Shikoku Chemicals Corporation), was put in a PI film-shaped frame (6 cm×4 cm) having a thickness of 125 μm, and pressed together with a Teflon (registered trademark) sheet (release paper) and a stainless steel plate to obtain a cured film. As a pressing machine, MINI TEST PRESS-10 (manufactured by Toyo Seiki Seisaku-sho, Ltd.) was used. Processing conditions for obtaining the cured film were as follows. Pressing at 5 MPa was carried out while the temperature was increased in the following manner: 180° C. for 30 minutes; 200° C. for 30 minutes; and then 220° C. for 2 hours. The Tg of this film-shaped cured product was 180° C. from the results of the DMA measurement. In addition, the elastic modulus at room temperature was 3.9 GPa. A DMA curve is shown in FIG. 8.

### Comparative Example 2

### Production Process:

To a reaction container equipped with a stirrer, 1,3-bis(4-aminophenoxy)benzene (6.0000 g, 0.0205 mol), paraformaldehyde (2.5886 g, 0.0862 mol), 4-hydroxybenzaldehyde (5.0128 g, 0.0410 mol), and toluene (31.7366 g) were added. These were reacted for 6 hours, while being refluxed. After an obtained reaction solution (A) was cooled to room temperature, the reaction solution (A) was dripped in stirred hexane (500 mL), so that a viscous precipitate was obtained. After a supernatant was removed, the precipitate was washed and stirred in methanol (500 mL), and then filtration was carried out. The obtained precipitate was dried at room temperature under reduced pressure for 2 hours with use of a vacuum dryer to obtain a benzoxazine compound (b), which was a reaction intermediate.

Subsequently, to a reaction container equipped with a stirrer, the obtained benzoxazine compound (b) (5.0000 g, 0.0086 mol), 1,3-bis(4-aminophenoxy)benzene (2.3809 g, 0.0081 mol), and chloroform (17.2220 g) were added. These were reacted for 2 hours, while being refluxed. After an obtained reaction solution (B) was cooled to room temperature, 20 mL of chloroform was added. An obtained solution was dripped in stirred methanol (300 mL), and then filtration was carried out. This operation was repeated once more, and then drying was carried out at 85° C. under reduced pressure for 1.5 hours with use of a vacuum dryer to obtain an imino group-containing benzoxazine compound (c), which was a target object.

A benzoxazine solution (27 wt %) was prepared by dissolving, in 1,4-dioxane, the imino group-containing benzoxazine compound (c) obtained in the above-described process. A PP plate (base material) was fixed on a smooth glass, and the benzoxazine solution was casted on the base material with use of a glass rod. A Teflon (registered trademark) sheet was used to adjust a thickness. Thereafter, the base material on which the benzoxazine solution was casted was covered with a vat so that steep volatilization of the solvent was prevented, and then left to stand still overnight.

From an obtained casted film, a cured film was obtained under the following processing conditions. The casted film was heated at 50° C. for 30 minutes, at 75° C. for 30 minutes, and then at 90° C. for 30 minutes with use of an oven. Subsequently, pressing at 2 MPa was carried out with respect to an obtained self-supporting film while the temperature was increased in the following manner: 95° C. for 1 hour; 120° C. for 1 hour; 150° C. for 1 hour; 190° C. for 2 hours; and then 220° C. for 1 hour. As a pressing machine, AYSR-10 (manufactured by Shinto Metal Industries, Ltd.) was used.

The above-described process corresponds to the production process described in Patent Literature 2. The Tg of this film-shaped cured product was 233° C. from the results of the DMA measurement. In addition, the elastic modulus at room temperature was 3.6 GPa. A DMA curve is shown in FIG. 8.

### Comparative Example 3

### Production Process:

To a reaction container equipped with a stirrer, 160.0000 g (0.5473 mol) of 1,3-bis(4-aminophenoxy)benzene, 69.0298 g (2.2987 mol) of paraformaldehyde, 133.6745 g (1.0946 mol) of 4-hydroxybenzaldehyde, and 846.3099 g of toluene were added. These were reacted for 6 hours, while being refluxed. After an obtained reaction solution (C) was cooled to room temperature, the reaction solution (C) was dried at 60° C. under reduced pressure with use of an evaporator to obtain a benzoxazine compound (d), which was a reaction intermediate.

Subsequently, to a reaction container equipped with a stirrer, 321.0320 g (0.5491 mol) of a benzoxazine compound (d), 107.0070 g (0.3660 mol) of 1,3-bis(4-aminophenoxy)benzene, and 998.7577 g of chloroform were added. These were reacted for 7 hours, while being refluxed. After an obtained reaction solution (D) was cooled to room temperature, the reaction solution (D) was dried under reduced pressure with use of an evaporator and a vacuum dryer. Thereafter, a dried product was washed in methanol, and then filtration was carried out. This operation was repeated once more, and then drying was carried out under reduced pressure at 25° C. for 2 hours, at 30° C. for 6 hours, and at 40° C. for 2 hours with use of a vacuum dryer to obtain an imino group-containing benzoxazine compound (e), which was a target object.

A benzoxazine solution (50 wt %) was prepared by dissolving, in 1,3-dioxolane, the imino group-containing benzoxazine compound (e) obtained in the above-described process. A NITOFLON film No. 900UL (base material) was fixed on a smooth glass, and the benzoxazine solution was casted on the base material with use of a glass rod. A Teflon (registered trademark) sheet was used to adjust a thickness. Thereafter, the base material on which the benzoxazine solution was casted was covered with a vat so that steep volatilization of the solvent was prevented, and then left to stand still overnight.

From an obtained casted film, a cured film was obtained under the following processing conditions. The cured film: the casted film was heated at 50° C. for 30 minutes, at 70° C. for 30 minutes, at 80° C. for 2 hours, and then at 120° C. for 1 hour with use of a vacuum laminator. Subsequently, pressing at 2 MPa was carried out with respect to an obtained self-supporting film while the temperature was increased in the following manner: 150° C. for 1 hour, 190° C. for 2 hours, and then 220° C. for 1 hour. As a pressing machine, AYSR-10 (manufactured by Shinto Metal Industries, Ltd.) was used.

The above process corresponds to the production process described in Patent Literature 2. The Tg of this film-shaped cured product was 325° C. from the results of the DMA measurement. In addition, the elastic modulus at room temperature was 3.7 GPa. A DMA curve is shown in FIG. 8.

### Conclusion

It was found that the cured films in Examples 2 and 7 had a higher Tg and were more excellent in heat resistance than the cured film in Comparative Example 1. The heat resistance of each of the cured films in Examples 2 and 7 is equivalent to the heat resistance of each of the cured films prepared by the multistep production processes described in Patent Literature 2, which are shown in Comparative Examples 2 and 3.

From the above, it can be said that the cured product of a benzoxazine compound containing a dynamic covalent bond in accordance with an embodiment of the present invention exhibits excellent heat resistance while realizing a more advantageous production process.

### <Decomposability Evaluation 1 of Cured Film of Solid Obtained by Mixing and Drying Raw Materials for Imino Group-Containing Benzoxazine Compound>

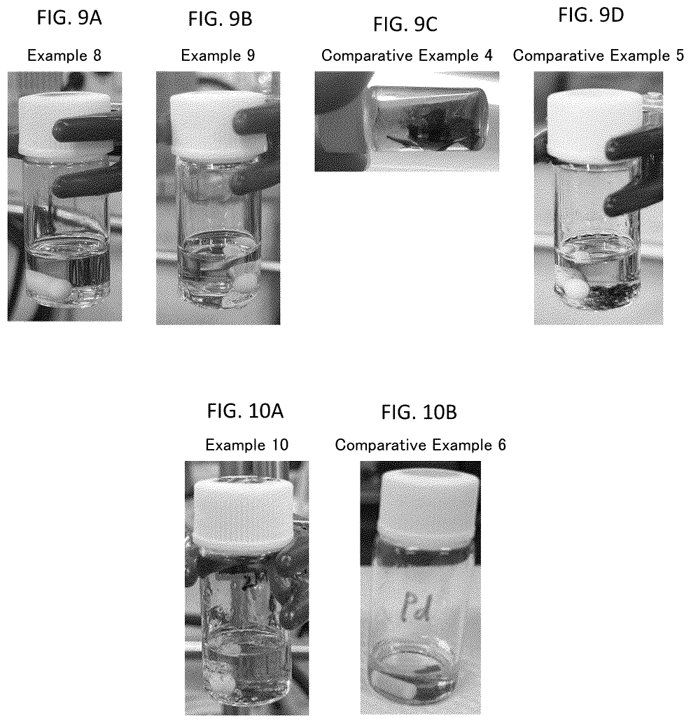

Table 4 below shows physical properties in each of Examples and Comparative Examples. In addition, FIGS. 9A-9D show results of an amine decomposability evaluation test (decomposability evaluation 1) in each of Examples and Comparative Examples. Note that, in FIGS. 9A-9D, cylindrical objects which are commonly observed in containers in Examples and Comparative Examples are stirrers.

### Criteria of Evaluation

A: Amine decomposition occurred.
B: Amine decomposition did not occur.

### Example 8

To a reaction container equipped with a stirrer, a film-shaped cured product (0.008 g) of the imino group-containing benzoxazine compound obtained in Example 7, hexamethylenediamine (0.4 g), and 1 mL of NMP were added. These were reacted at 170° C. for 1 minute.

### Example 9

To a reaction container equipped with a stirrer, a film-shaped cured product (0.008 g) of the imino group-containing benzoxazine compound obtained in Example 7, hexamethylenediamine (0.4 g), and 1 mL of DMF were added. These were reacted at 100° C. for 15 minutes.

### Comparative Example 4

To a reaction container equipped with a stirrer, a film-shaped cured product (0.008 g) of the imino group-containing benzoxazine compound obtained in Comparative Example 3, hexamethylenediamine (0.4 g), and 1 mL of NMP were added. These were reacted at 170° C. for 1 minute.

### Comparative Example 5

To a reaction container equipped with a stirrer, a film-shaped cured product (0.008 g) of the imino group-containing benzoxazine compound obtained in Comparative Example 3, hexamethylenediamine (0.4 g), and 1 mL of DMF were added. These were reacted at 100° C. for 15 minutes.

From Table 4 and FIGS. 9A-9D, it was found that the cured films in Examples 8 and 9 exhibited amine decomposability. It is considered that these cured films each exhibited decomposability due to an imine exchange reaction, with the added amine, of a dynamic covalent bond (imine bond) introduced into a structure, despite being a cured product obtained by use of a resin composition containing a benzoxazine compound, which corresponds to a thermosetting resin. Exhibiting decomposability under the evaluation conditions of the present Examples means that low molecular weight compounds can be produced by chemically decomposing a cured product of a benzoxazine compound, in other words, a cured product of a thermosetting resin. Therefore, it is also considered possible to recycle, for example, chemically recycle the cured product obtained by use of the resin composition in accordance with an embodiment of the present invention.

In contrast, it was found that the cured films in Comparative Example 4 (decomposition condition corresponding to Example 8) and Comparative Example 5 (decomposition condition corresponding to Example 9) did not exhibit amine decomposability. Not only these Comparative Examples but also a cured product of a general thermosetting resin do not have a dynamic covalent bond. Therefore, it is considered that the cured films in Comparative Examples 4 and 5 did not exhibit decomposability under the evaluation conditions of the present Examples.

### <Decomposability Evaluation 2 of Cured Film of Solid Obtained by Mixing and Drying Raw Materials for Imino Group-Containing Benzoxazine Compound>

Table 4 below shows physical properties in each of Examples and Comparative Examples. In addition, FIGS. 10A-10B shows results of a hydrolyzability evaluation test (decomposability evaluation 2) in each of Examples and Comparative Examples. Note that, in FIGS. 10A-10B, cylindrical objects which are commonly observed in containers in Examples and Comparative Examples are stirrers.

### Criteria of Evaluation

A: Hydrolysis occurred.
B: Hydrolysis did not occur.

### Example 10

To a reaction container equipped with a stirrer, a film-shaped cured product (0.003 g) of the imino group-containing benzoxazine compound obtained in Example 7 and a 2M HCl aqueous solution/THF (1/3, v/v) (1.4816 g) were added. These were reacted at 55° C. for 18 hours.

### Comparative Example 6

To a reaction container equipped with a stirrer, a film-shaped cured product (0.003 g) of the imino group-containing benzoxazine compound obtained in Comparative Example 3 and a 2M HCl aqueous solution/THF (1/3, v/v) (1.4816 g) were added. These were reacted at 55° C. for 18 hours.

From Table 4 and FIGS. 10A-10B, it was found that the cured film in Example 10 exhibited hydrolyzability. It is considered that this cured film exhibited hydrolyzability due to a dynamic covalent bond (imine bond) introduced into a main chain, despite being a cured product obtained by use of a resin composition containing a benzoxazine compound, which corresponds to a thermosetting resin. Exhibiting hydrolyzability under evaluation conditions of the present Examples means that low molecular weight compounds can be produced by chemically decomposing a cured product of a benzoxazine compound, in other words, a cured product of a thermosetting resin. Therefore, it is also considered possible to recycle, for example, chemically recycle the cured product obtained by use of the resin composition in accordance with an embodiment of the present invention.

In contrast, it was found that the cured film in Comparative Example 6 did not exhibit hydrolyzability. Not only this Comparative Example but also a cured product of a general thermosetting resin do not have a dynamic covalent bond. Therefore, it is considered that the cured film in Comparative Example 6 did not exhibit hydrolyzability under the evaluation conditions of the present Examples.

TABLE 4

| | | | | Decomposability | |
|---|---|---|---|---|---|
| Decomposability evaluation 1 | | | | evaluation 2 | |
| (amine decomposition) | | | | (hydrolysis) | |
| | | Compar- | Compar- | | Compar- |
| | | ative | ative | | ative |
| Example | Example | Example | Example | Example | Example |
| 8 | 9 | 4 | 5 | 10 | 6 |
| A | A | B | B | A | B |

### Conclusion

As is clear from the above, the cured product of a benzoxazine compound containing a dynamic covalent bond in accordance with an embodiment of the present invention exhibits amine decomposability and hydrolyzability. It is considered that this makes it possible to recycle the cured product in which the resin composition containing the benzoxazine compound in accordance with an embodiment of the present invention is used as a thermosetting resin, by decomposing the cured resin. Furthermore, in the carbon fiber composite material in which the resin composition containing the benzoxazine compound in accordance with an embodiment of the present invention is used as a thermosetting resin, it is considered possible to recycle not only the resin but also the carbon fibers by decomposing the cured resin component.

### <Preparation 2 of Imino Group-Containing Benzoxazine Prepreg and CFRP>

### Example 11

To a reaction container equipped with a stirrer, a solution A of the benzoxazine compound (a) obtained in Production Example 1 (37.10 g, 0.0726 mol) and 1,3-dioxolane (60.53 g) and a solution B of 2,2-bis[4-(4-aminophenoxy)phenyl]propane (31.32 g, 0.0762 mol) and 1,3-dioxolane (51.10 g) were added. A resulting mixture was stirred at room temperature for 5 minutes to obtain a raw material mixed solution of an imino group-containing benzoxazine compound. In a solution bath into which the raw material mixed solution was poured, carbon fibers (T300-6K, manufactured by Toray Industries, Inc.) (fineness: 396 Tex, density: 1.76 g/cm³) were impregnated with the raw material mixed solution. Then, the carbon fibers were wound at a width-feeding speed of 18.35 mm/min around a drum that was rotated at a winding speed of 8 m/min. In this way, a unidirectional prepreg (weight per unit area of fibers: 145 g/m²) measuring 20 cm in width and 100 cm in length was prepared.

This operation was repeated three times, and three unidirectional prepregs each measuring 20 cm in width and 100 cm in length were obtained. Five sheets each measuring 15 cm were cut out from each of the prepregs, and a total of 15 sheets of 15-cm square prepreg were obtained. The weight of the solution contained in the prepreg was approximately 60 wt %, and the weight of the carbon fibers contained in the prepreg was approximately 40 wt %.

### Example 12

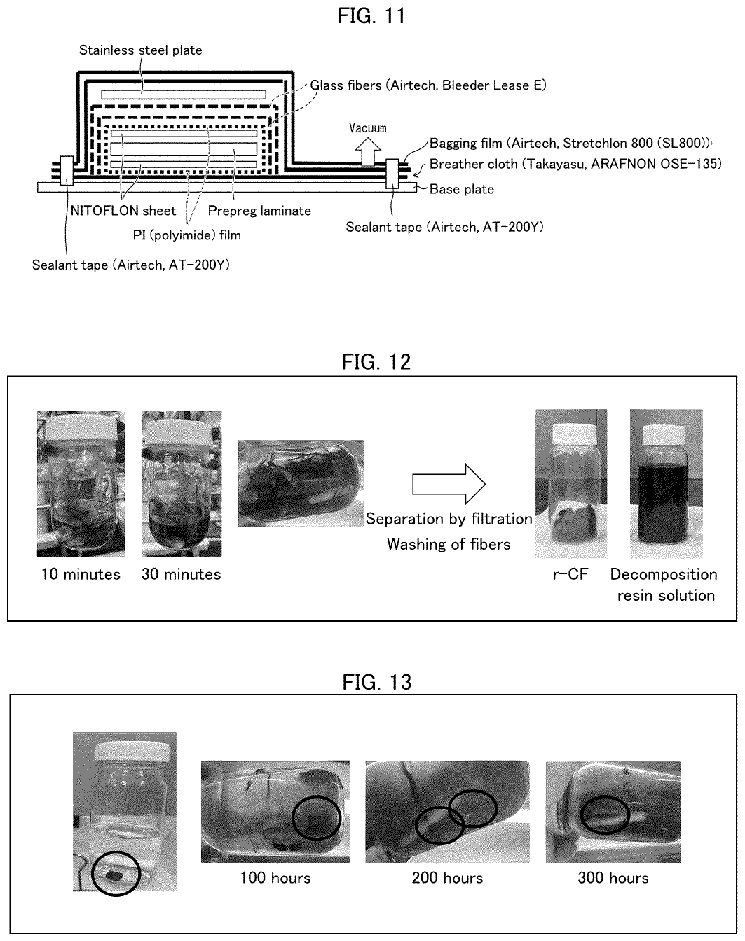

The prepregs obtained in Example 11 were stacked on top of each other to obtain a 15-layer prepreg. The obtained prepreg laminate was sandwiched between two NITOFLON sheets (release paper) (in FIG. 11, white rectangles shown on and under the prepreg laminate), and wrapped with a PI (polyimide) film (in FIG. 11, a rectangle which is shown by a dotted line and which encloses the prepreg laminate and the NITOFLON sheets). This wrapped prepreg laminate was placed as shown in FIG. 11. With use of a press molding machine, (1) the wrapped prepreg laminate was heated at 30° C. for 30 minutes under a vacuum condition, (2) the wrapped prepreg laminate was pressed at 0.7 MPa under a vacuum condition and maintained at 90° C. for 3 minutes, (3) the wrapped prepreg laminate was pressed at 1.4 MPa under a vacuum condition, a temperature thereof was increased to 95° C., (4) the wrapped prepreg laminate was pressed at 2 MPa under a vacuum condition, a temperature thereof was increased to 150° C., and (5) thereafter, the temperature was decreased to 100° C. After that, subsidiary materials (glass fibers, a bagging film, breather cloth, and a sealant tape) were removed, and the stainless steel plate was replaced by the base plate. Then, the prepreg laminate was pressed at 2 MPa and heated at 220° C. for 1 hour so as to be cured. Materials used are shown below.
Stainless steel plate: 2 mm thickness
Glass fibers: manufactured Airtech, product name: Bleeder Lease E
Bagging film: manufactured by Airtech, product name: Stretchlon 800 (SL800)
Breather cloth: manufactured by Takayasu Co., Ltd., product name: ARAFNON OSE-135
Sealant tape: manufactured by Airtech, AT-200Y
Base plate: 3 mm thickness
NITOFLON sheet: manufactured by Nitto Denko Corporation, product name: 9700UL
PI film: 75 micron thickness
As a pressing machine, AYSR-10 (manufactured by Shinto Metal Industries, Ltd.) was used.

### <Decomposability Evaluation 1 of Imino Group-Containing Benzoxazine CFRP>

### Example 13

A 1-cm square test piece was cut out from the plate-shaped CFRP obtained in Example 12 with use of a diamond cutter. The test piece (0.3816 g) (estimated resin amount: 0.1546 g, estimated weight of carbon fibers: 0.2270 g), hexamethylenediamine (7.7284 g), and 20 mL of NMP were added, and reacted at 170° C. for 30 minutes in total.

### Criteria of Evaluation of Decomposability:

A: The cured resin component was completely dissolved, and the carbon fibers were loosened.
B: The cured resin component was largely dissolved, and the solution was colored. However, the shape of the carbon fibers was partially maintained.
C: The cured resin component was partially dissolved, and the solution was colored. However, the shape of the carbon fibers was largely maintained.
D: The cured resin component was not dissolved at all, and also coloring of the solution was not observed. The state of decomposition is shown in FIG. 12.

### Example 14

A decomposition resin solution obtained in Example 13 was subjected to filtration so that the carbon fibers were recovered. Thereafter, the carbon fibers were washed in acetone for 2 hours, and then filtration was carried out. This was repeated twice, and the carbon fibers were dried at 100° C. for 5 hours in a vacuum oven. The obtained carbon fibers were regarded as recycled carbon fibers (r-CF). The states of the r-CF and the decomposition resin solution which were separated from the CFRP are shown in FIG. 12.

It could be confirmed from Example 13 that the resin cured product component of the CFRP was completely decomposed, and the carbon fibers were loosened. Thus, the evaluation was given a rating of “A”. From Example 14, it was found that the recovery of r-CF was made possible by decomposition of CFRP.

### <Decomposability Evaluation 2 of Imino Group-Containing Benzoxazine CFRP>

### Example 15

A 1-cm square test piece was cut out from the plate-shaped CFRP obtained in Example 12 with use of a diamond cutter. The test piece (0.3869 g) (estimated resin amount: 0.1499 g, estimated weight of carbon fibers: 0.2190 g) and a 2M HCl aqueous solution/THF (1/3, v/v) (81.4880 g) were added, and reacted at 55° C. for 300 hours in total.

### Criteria of Evaluation of Decomposability:

A: The cured resin component was completely dissolved, and the carbon fibers were loosened.
B: The cured resin component was largely dissolved, and the solution was colored. However, the shape of the carbon fibers was partially maintained.
C: The cured resin component was partially dissolved, and the solution was colored. However, the shape of the carbon fibers was largely maintained.
D: The cured resin component was not dissolved at all, and also coloring of the solution was not observed. The state of decomposition is shown in FIG. 13.

It could be confirmed from Example 15 that the shape of the carbon fibers was partially maintained, but the resin cured product component of the CFRP was largely dissolved. Thus, the evaluation was given a rating of “B”.

### (Conclusion)

Thus, regarding the CFRP in accordance with an embodiment of the present invention, in which the cured product of the imino group-containing benzoxazine compound is used as a matrix resin, it is possible to recycle the carbon fibers due to amine decomposability and hydrolyzability of the cured resin component.

### <Glass Transition Temperature of CFRP>

### Example 16

The plate-shaped CFRP obtained in Example 12 was cut with use of a diamond cutter and post-cured at 250° C. for 30 minutes in an oven. The glass transition temperature Tg of the post-cured plate-shaped CFRP was determined with use of a dynamic viscoelasticity measurement device. The Tg was 220° C.

It was found that the CFRP in accordance with an embodiment of the present invention, in which the cured product of the benzoxazine compound containing the dynamic covalent bond was used as a matrix resin, exhibited excellent heat resistance similarly to the cured resin film.

### <Interlaminar Shear Strength of CFRP>

### Example 17

The plate-shaped CFRP obtained in Example 12 was cut with use of a diamond cutter, a short beam shear (SBS) test was carried out with use of a universal test machine (AG-10 TB, manufactured by SHIMADZU). The size of the test piece and the conditions of the test were set in conformity with ASTMD2344, and the interlaminar shear strength of the CFRP was determined by the following formula:

$$Interlaminar shear strength [ MPa ] = 3 \times interlaminar shear load [ N ] / ( 4 \times test piece width [ mm ] \times test piece thickness [ mm ] )$$

The interlaminar shear strength was 85 MPa.

### <Bending Elastic Modulus and Bending Strength of CFRP>

### Example 18

The plate-shaped CFRP obtained in Example 12 was cut with use of a diamond cutter, a bending test was carried out with use of a universal test machine (INSTRON 5982, manufactured by INSTRON) and a deflectometer (CDP-50MT, Tokyo Measuring Instruments Laboratory Co., Ltd.). The size of the test piece and the conditions of the test were set in conformity with ASTMD7264. The elastic modulus was 102 MPa, and the bending strength was 1444 MPa.

### INDUSTRIAL APPLICABILITY

An aspect of the present invention can be used in the fields in which thermosetting resins are used.

1. A method for producing a prepreg, the method comprising the step of mixing, with reinforcement fibers, a resin composition containing a compound (A) having a benzoxazine ring and an aldehyde group and an aromatic amine compound (B), wherein
the resin composition contains the aldehyde group in an amount of not less than 50 mol %, where 100 mol % represents a total amount of the aldehyde group and an imino group in the resin composition.

2. The method according to claim 1, wherein the resin composition is a resin composition in a solution state.

3. The method according to claim 2, wherein the resin composition contains a solvent in an amount of not more than 68% by weight.

4. The method according to claim 1, wherein the compound (A) has two to five aldehyde groups, and the compound (B) has two to five amino groups.

5. The method according to claim 1, wherein the compound (A) is a compound represented by the following general formula (I): 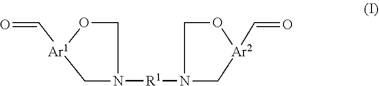
where: Ar¹ and Ar² each represent a trivalent aromatic group derived from a phenol compound, Ar¹ and Ar² may be identical to or different from each other, and R¹ represents a divalent aromatic group; and Ar¹, Ar², and R¹ each do not have a C═N group.

6. The method according to claim 1, wherein the aromatic amine compound (B) is at least one compound selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminodiphenylmethane, 4,4′-diaminodiphenylether, 4,4′-diaminobenzophenone, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy) biphenyl, 4,4′-bis(4-aminophenoxy) biphenyl, and 9,9-bis(4-aminophenyl) fluorene.

7. A method for producing a fiber composite material, the method comprising the step of producing a prepreg by a production method recited in claim 1 and then heating the prepreg to a temperature of not lower than 150° C.

8. A resin composition comprising: a compound (A) having a benzoxazine ring and an aldehyde group; and an aromatic amine compound (B), wherein
the resin composition contains the aldehyde group in an amount of not less than 50 mol %, where 100 mol % represents a total amount of the aldehyde group and an imino group in the resin composition, and
the resin composition contains a solvent in an amount of not less than 0% by weight and not more than 68% by weight.

9. The resin composition according to claim 8, wherein the compound (A) has two to five aldehyde groups, and the compound (B) has two to five amino groups.

10. The resin composition according to claim 8, wherein the compound (A) is a compound represented by the following general formula (I): 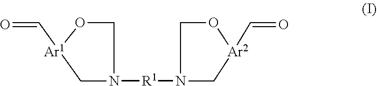
where: Ar¹ and Ar² each represent a trivalent aromatic group derived from a phenol compound, Ar¹ and Ar² may be identical to or different from each other, and R¹ represents a divalent aromatic group; and Ar¹, Ar², and R¹ each do not have a C═N group.

11. The resin composition according to claim 8, wherein the aromatic amine compound (B) is at least one compound selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminodiphenylmethane, 4,4′-diaminodiphenylether, 4,4′-diaminobenzophenone, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy) biphenyl, 4,4′-bis(4-aminophenoxy) biphenyl, and 9,9-bis(4-aminophenyl) fluorene.

12. The resin composition according to claim 8, wherein the resin composition contains reinforcement fibers.

13. A prepreg consisting of a resin composition recited in claim 12.

14. A method for producing a resin composition in which an imino group is present in a large amount, the method comprising the step of heating a resin composition recited in claim 8 which is in a solution state until the amount of the imino group in the resin composition becomes more than 50 mol %, where 100 mol % represents a total amount of an aldehyde group and the imino group in the resin composition.

15. A method for producing a resin composition in which an imino group is present in a large amount, the method comprising the step of heating a resin composition recited in claim 8 which is in a solid state until the amount of the imino group in the resin composition becomes not less than 70 mol %, where 100 mol % represents a total amount of an aldehyde group and the imino group in the resin composition.

16. A method for producing a cured product, the method comprising the step of producing a resin composition recited in claim 8 and then heating the resin composition to a temperature of not lower than 150° C.

17. A method for producing a fiber composite material, the method comprising the step of producing a prepreg recited in claim 13 and then heating the prepreg to a temperature of not lower than 150° C.

18. A method for decomposing a cured product that is obtained by curing a resin composition in a prepreg which has been obtained by a production method recited in claim 1, the method comprising the step of decomposing the cured product under an acidic or basic condition.

19. A method for decomposing a fiber composite material that has been obtained by a production method recited in claim 7, the method comprising the step of decomposing the fiber composite material under an acidic or basic condition.

20. A method for decomposing a cured product that is obtained by curing a resin composition recited in claim 8, the method comprising the step of decomposing the cured product under an acidic or basic condition.
